(19) United States
(12) Patent Application Publication
(10) Pub. No.: US 2025/0074358 A1
(43) Pub. Date: Mar. 6, 2025

(54) MOBILE TERMINAL APPARATUS, METHOD OF OPERATING AUTONOMOUS VEHICLE, METHOD OF IDENTIFYING MOBILE TERMINAL APPARATUS, AND METHOD OF TRANSMITTING INFORMATION

(71) Applicant: Maxell, Ltd., Kyoto (JP)

(72) Inventors: Kenji KASAI, Kyoto (JP); Hirokazu ISHII, Kyoto (JP)

(21) Appl. No.: 18/722,392

(22) PCT Filed: Dec. 23, 2021
(86) PCT No.: PCT/JP2021/048023

§ 371 Date: Jun. 20, 2024

(51) Int. Cl. B60R 25/24; H04W 8/00; H04W 84/20

(52) U.S. Cl. CPC B60R 25/241; H04W 8/005; H04W 84/20

(57) ABSTRACT

A technique of more suitably achieving an operation of an autonomous vehicle used by a plurality of members is provided. A mobile terminal apparatus includes: a controller transmitting an operation instruction for operating the autonomous vehicle to an in-vehicle apparatus of the autonomous vehicle; and a storage storing setting information including information for identifying each user terminal and ranking information for setting a ranking related to the operation of the autonomous vehicle, among the plurality of users making a group using the autonomous vehicle and the plurality of mobile terminal apparatuses. The mobile terminal apparatus detects other user terminal of the group by communication with the other user terminal, determines, on the basis of the ranking information of the setting information, whether or not the terminal itself has an operation privilege for transmitting the operation instruction while taking the terminal itself and the other user terminal as candidate user terminals, and, if the terminal itself has the operation privilege, transmits the operation instruction to the in-vehicle apparatus on the basis of an input operation performed by the user.

### TECHNICAL FIELD

The present invention relates to a technique for a mobile terminal apparatus and an autonomous vehicle, and particularly to a mobile terminal apparatus enabling cooperation with the autonomous vehicle through communication or the like.

### BACKGROUND ART

A technique of a vehicle (which may be described as an autonomous vehicle) enabling autonomous driving has been developed. The spread of the autonomous vehicle is expected in the near future by the development of related techniques such as 5G and IoT. According to an autonomous driving level determined by U.S. Society of Automotive Engineers, some autonomous vehicles classified into Level 3 has started to be put into practical use. Level 3 is an autonomous vehicle level in which manual driving by a driver and autonomous driving by an automobile are operated while being switched depending on a situation. Further, when the autonomous driving level is Level 4 or Level 5, the autonomous vehicle is a fully autonomous vehicle not requiring the driving operation by the driver. In this case, it is not essential to acquire driving skills, and it is expected that even a person who does not have a conventional driver's license can use the autonomous vehicle as daily movement means. Note that the specification of the present application describes each autonomous vehicle at Level 3 and preceding levels as a partially autonomous vehicle, and describes each autonomous vehicle at Level 4 or Level 5 as a fully autonomous vehicle unless otherwise noted, and collectively describes them as an autonomous vehicle.

Currently, in a general vehicle, an operation privilege on the vehicle is mainly managed by a physical key (which may be described as a vehicle key) for vehicle operation (particularly including unlocking and locking of a door and ignition). Further, a technique for digitizing a function of the vehicle key or the driver's license has also been proposed. For example, a technique for enabling a predetermined operation of the vehicle by mounting the function of the vehicle key or the driver's license as digital data onto a mobile terminal apparatus such as a smartphone and operating the mobile terminal apparatus by a user has also been proposed.

In a future use scene of the autonomous vehicle, a plurality of persons can be candidates for the operation of the vehicle. Note that an operator is not limited to an occupant. As an example of a use form, it is assumed that a family of four members who are two adults and two children owns one autonomous vehicle, all family members can individually operate the autonomous vehicle, and, for example, any one of them designates a destination and moves thereto by autonomous driving. Accordingly, in such a use form, it is necessary to consider how the operation privilege on the autonomous vehicle is to be managed and controlled by the plurality of persons. For example, it is necessary to consider a mechanism for determining who of the family members representatively has the operation privilege and consider a user interface, a man-machine interface, or the like suitable for the mechanism.

As an example of related-art techniques, Japanese Patent Application Laid-Open Publication No. 2020-158006 (Patent Document 1) is exemplified. The Patent Document 1 discloses a driving support method or the like of smoothly transferring the operation privilege on the autonomous vehicle among a plurality of occupants who ride on the autonomous vehicle. Further, the Patent Document 1 discloses that a controller performs processing for identifying the plurality of occupants of the autonomous vehicle, processing for determining qualification for the operation privilege given to each of the occupants, and processing for displaying the qualification for the operation privilege given to each of the occupants.

### RELATED ART DOCUMENT

### Patent Document

Patent Document 1: Japanese Patent Application Laid-Open Publication No. 2020-158006

### SUMMARY OF THE INVENTION

### Problems to be Solved by the Invention

When a plurality of members of a family or the like (which may be described as a group) use a future autonomous vehicle, an example of a use form is assumed as follows. A mobile terminal apparatus such as a smartphone carried and used by each of users of the family is provided with a function of cooperating with the autonomous vehicle, in other words, a function of being able to issue an operation instruction to an in-vehicle apparatus. The mobile terminal apparatus of each of the users may store key information (digital data corresponding to a vehicle key) indicating that the user is a legitimate user of the autonomous vehicle. At the time of use of the autonomous vehicle, each of the users uses a physical vehicle key or key information in the mobile terminal apparatus, to unlock a door to ride thereon. Further, a graphical user interface (GUI) enabling the operation instruction to the autonomous vehicle is displayed on a screen of the mobile terminal apparatus of each of the users. Each of the users can perform the operation instruction (such as a destination instruction) to the autonomous vehicle by performing an input operation to the screen. An in-vehicle apparatus (such as an electronic controller unit: ECU) of the autonomous vehicle controls autonomous driving of the autonomous vehicle in accordance with the operation instruction received from the mobile terminal apparatus.

For example, the Patent Document 1 discloses that a person who currently has the operation privilege can easily understand to whom the operation privilege can be transferred, by a method of displaying an icon representing the qualification for the operation privilege given to each of occupants as illustrated in FIG. 2A. It is considered that the transfer of the operation privilege among the plurality of occupants can be supported by the technique as in the Patent Document 1.

However, the Patent Document 1 does not specifically describe, for example, when a plurality of legitimate occupants for the autonomous vehicle simultaneously have the qualification for the operation privilege at the time of riding, which one of the occupants first acquires the operation privilege. In such a technique as in Patent Document 1, each of the occupants needs to, for example, determine who has the operation privilege. In such a technique as in Patent Document 1, a mechanism or the like for being able to automatically and easily determine the person who representatively has the operation privilege, in the group made of the plurality of members, has been insufficiently examined.

Further, in such a technique as in Patent Document 1, an attribution of a user who is the occupant is previously input and set through an input apparatus, and is stored in a memory. In such a technique, if there are a plurality of vehicles that can be ridden and used by a certain user, the attribution of the user needs to be input and set every time of change of the vehicle to be ridden by the user, and therefore, the technique needs a lot of time and effort.

An object of the present invention relates to a technique of a mobile terminal apparatus enabling an operation instruction to an autonomous vehicle, and is to provide a technique capable of more preferably operating the autonomous vehicle when the autonomous vehicle is used by a plurality of members of a family or the like.

### Means for Solving the Problems

A typical embodiment of the present invention has a configuration described below. A mobile terminal apparatus according to the embodiment is a mobile terminal apparatus carried by each of a plurality of users who can use an autonomous vehicle, and the mobile terminal apparatus includes: a controller configured to transmit an operation instruction for operating the autonomous vehicle to an in-vehicle apparatus of the autonomous vehicle; and a storage configured to store setting information including information for identifying each user or mobile terminal apparatus and ranking information for setting a ranking related to an operation of the autonomous vehicle, among the plurality of users making a group using the autonomous vehicle and the plurality of mobile terminal apparatus. The mobile terminal apparatus detects a mobile terminal apparatus of other user of the group by communication with the mobile terminal apparatus of the other user, and then, determines, on the basis of the ranking information of the setting information, whether or not the terminal itself has an operation privilege for transmitting the operation instruction while taking the terminal itself and the detected mobile terminal apparatus of the other user as candidate user terminals, and, if the terminal itself has the operation privilege, transmits the operation instruction to the in-vehicle apparatus on the basis of an input operation performed by the user.

### Effects of the Invention

According to a typical embodiment of the present invention, related to a technique of a mobile terminal apparatus enabling an operation instruction to an autonomous vehicle, the autonomous vehicle can be more preferably operated when being used by a plurality of members of a family or the like. Other problems, configurations, effects and the like than those of the above description will be described in the following section <DETAILED DESCRIPTION OF PREFERRED EMBODIMENTS>.

### BRIEF DESCRIPTIONS OF THE DRAWINGS

FIG. 1 illustrates a schematic configuration of an autonomous vehicle system including a mobile terminal apparatus according to a first embodiment of the present invention.

FIG. 2 illustrates an explanatory diagram related to step S1 in the first embodiment.

FIG. 3 illustrates an explanatory diagram related to steps S2 and S3 in the first embodiment.

FIG. 4 illustrates an explanatory diagram related to step S4 in the first embodiment.

FIG. 5 illustrates an explanatory diagram related to a display example in an in-vehicle apparatus in the first embodiment.

FIG. 6 illustrates a functional block configuration of the mobile terminal apparatus according to the first embodiment.

FIG. 7 illustrates a main processing flow of the mobile terminal apparatus according to the first embodiment.

FIG. 8 illustrates an example of a processing sequence between each of user terminals and the in-vehicle apparatus in the first embodiment.

FIG. 9 illustrates a configuration example of key group management information in the first embodiment.

FIG. 10 illustrates a configuration example of operation setting information in the first embodiment.

FIG. 11 illustrates a system configuration example related to acquirement of key information or the like in the first embodiment.

FIG. 12 illustrates a configuration example of an operation menu screen in the first embodiment.

FIG. 13 illustrates a configuration example of a user list screen in the first embodiment.

FIG. 14 illustrates a configuration example of a key list screen in the first embodiment.

FIG. 15 illustrates a configuration example of an audio output in the first embodiment.

FIG. 16 illustrates an explanatory diagram related to a guest in a modification example of the first embodiment.

FIG. 17 illustrates an explanatory diagram related to a remote terminal in the modification example of the first embodiment.

FIG. 18 illustrates an explanatory diagram related to a vehicle position in the modification example of the first embodiment.

FIG. 19 illustrates a configuration example of an operation menu screen in the modification example of the first embodiment.

FIG. 20 illustrates a configuration example of primary and secondary user terminals in the modification example of the first embodiment.

FIG. 21 illustrates a configuration example of primary and secondary user terminals in the modification example of the first embodiment.

FIG. 22 illustrates a schematic configuration of an autonomous vehicle system including a mobile terminal apparatus according to a second embodiment of the present invention.

FIG. 23 illustrates a configuration example of driver information in the second embodiment.

FIG. 24 illustrates an example of a processing sequence between each of user terminals and an in-vehicle apparatus in the second embodiment.

FIG. 25 illustrates an example of a processing flow and a screen in the second embodiment.

FIG. 26 illustrates an explanatory diagram related to steering in a third embodiment.

FIG. 27 illustrates an example of users riding on a vehicle and a position of a mobile terminal apparatus owned by each of the users in the third embodiment.

### DETAILED DESCRIPTION OF PREFERRED EMBODIMENTS

Hereinafter, embodiments of the present invention will be described in detail with reference to the drawings. In the drawings, the same parts are denoted by the same reference symbols in principle, and repetitive description thereof is omitted. In the drawings, each expression of the components may not describe an actual position, size, shape, range, and the like in order to support understanding of the invention.

For the explanations, in explanation for a processing operated by a program, the program, the function, the processing portion, and the like may be explained as entities. However, the entities as hardware for these components are a processor, or a controller, an apparatus, a computer, a system, and the like configured by the processor and the like. In the computer, the processing is executed by the processor in accordance with the program loaded on the memory while appropriately using resources such as the memory and the communication interface. As a result, predetermined functions, processing portions, and the like are achieved. The processor is made of, for example, a semiconductor device such as a CPU or a GPU. The processor is made of a device or a circuit capable of performing a predetermined calculation. The processing is not limited to software program processing, and can be implemented by a dedicated circuit. As the dedicated circuit, FPGA, ASIC, CPLD or the like can be applied.

The program may be previously installed as data in the target computer, or may be distributed as data from a program source to the target computer. The program source may be a program distribution server on a communication network, or may be a non-transitory computer-readable storage medium (such as a memory card). The program may be made of a plurality of modules. The computer system may be made of not single apparatus but a plurality of apparatuses. The computer system may be made of a client server system, a cloud computing system, an IoT system or the like. The various pieces of data and information are expressed by, for example, a table, a list or the like, but are not limited thereto. Expressions for identification information, an identifier, an ID, a name, a number and the like can be exchanged with one another.

### Outline

A mobile terminal apparatus according to an embodiment includes a controller that displays a screen enabling an operation instruction to an autonomous vehicle and transmits the operation instruction to the autonomous vehicle (such as an in-vehicle apparatus) on the basis of an operation on the screen performed by a user. The mobile terminal apparatus previously stores setting information including ranking information that is set to be shared with a mobile information terminal of another user of a group. This ranking information is information representing a ranking (in other words, a degree of priority, etc.) for determining an operation privilege of the autonomous vehicle for a plurality of members (users) of the group such as a family. A mobile terminal apparatus (user terminal) of each of the users communicates with a mobile terminal apparatus (another user terminal) of the other user of the group. When detecting the other user terminal of the group in surroundings, the mobile terminal apparatus determines the presence or absence of the operation privilege between the terminal itself and the other user terminal in accordance with the ranking information. That is, it is determined which of the user terminals of the group has the operation privilege. The user terminal that has been determined to have the operation privilege can transmit the operation instruction to the in-vehicle apparatus in accordance with the operation on the screen performed by the user.

### First Embodiment

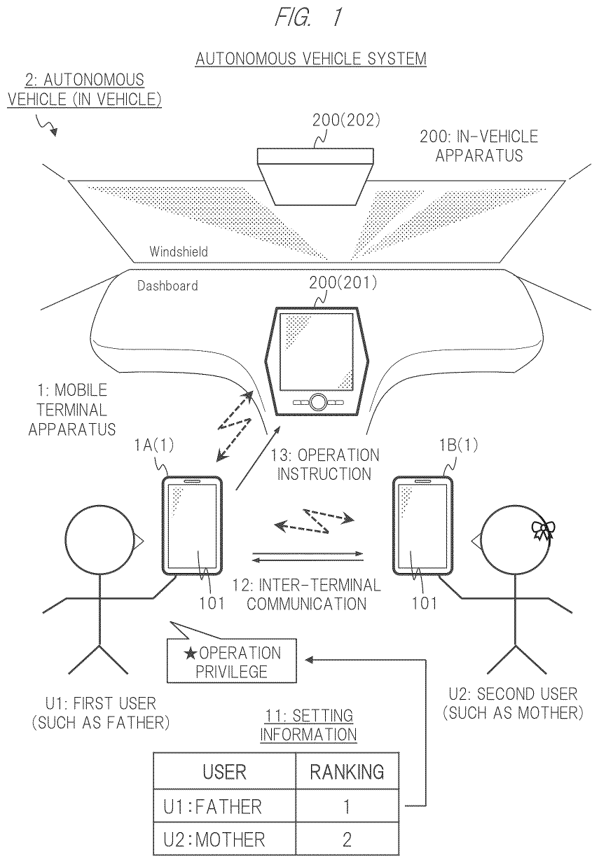

A mobile terminal apparatus and the like according to a first embodiment of the present invention will be described with reference to FIGS. 1 to 15. A method of operating the autonomous vehicle according to the first embodiment is a method including steps to be performed by the mobile terminal apparatus according to the first embodiment in an autonomous vehicle system configured to include the mobile terminal apparatus. As the first embodiment, an example of application of the present invention to an operation instruction to a fully autonomous vehicle will be mainly described. However, the present invention is not limited to this example, but is applicable to an autonomous vehicle of each level such as a partially autonomous vehicle. Note that a mobile terminal apparatus may be described as a terminal. A mobile terminal apparatus of a user may be described as a user terminal.

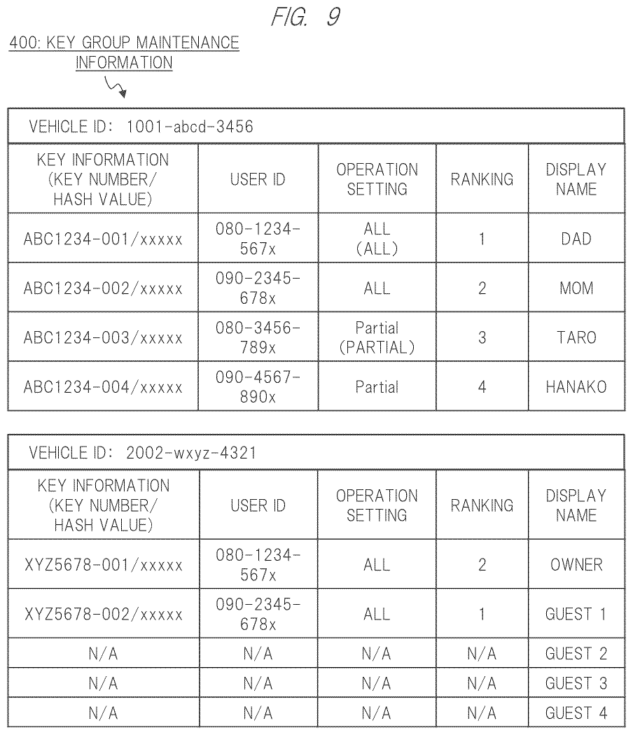

In the first embodiment illustrated in FIG. 1 and the like, a plurality of users related to use of an autonomous vehicle 2 as a specific vehicle are set as a group (also described as a key group) having a fundamental right enabling the users to ride on the specific vehicle. The key group is a group who owns key information as a vehicle key of the specific vehicle. A key group terminal (also described as a group terminal) is a mobile terminal apparatus 1 of the user of the key group. User terminals of the group previously share ranking information serving as setting information 11. In the first embodiment, the ranking information is set as a part of key group management information 400 illustrated in FIG. 9. The ranking information is information representing a ranking or a degree of priority for determining an operation privilege for each of the user terminals of the group.

For example, when a plurality of users of the group (such as family) are near the specific vehicle and attempt to ride thereon, each of user terminals detects the other user terminals of the group (key group terminals) by performing inter-terminal communication 12 (transmission and reception of existence notification information described later) within a predetermined distance range via a predetermined communication interface. If detecting the other user terminals, each of the user terminals compares the rankings among the terminal itself and the other user terminals on the basis of the ranking information, and determines whether or not the terminal itself has the operation privilege. Specifically, if the ranking of the terminal itself among candidate user terminals including the terminal itself and the other user terminals is the highest, it is determined that the terminal itself has the operation privilege. The operation privilege is a privilege allowing the user terminal to transmit the operation instruction 13 to the specific vehicle (the in-vehicle apparatus 200) in a cooperative function. The user terminal having the operation privilege can transmit the operation instruction 13 to the in-vehicle apparatus 200 of the specific vehicle on the basis of the input operation on the screen performed by the user. The in-vehicle apparatus 200 that has received the operation instruction 13 controls autonomous driving of the specific vehicle in accordance with the operation instruction 13.

### [Autonomous Vehicle System]

FIG. 1 illustrates the outline of the first embodiment, and illustrates a configuration example of a system (also described as an autonomous vehicle system) configured to include the mobile terminal apparatus 1 and the autonomous vehicle 2 in the first embodiment. In FIG. 1, an example in which a first user U1 and a second user U2 serving as two users are riding on the autonomous vehicle 2 is illustrated in a schematic diagram. The two users make one group. For example, the first user U1 is a father of the family, and the second user U2 is a mother thereof. Each of the users is a person who uses the autonomous vehicle 2 as a specific vehicle. Each of the users carries and uses the mobile terminal apparatus 1 such as a smartphone. In this example, the first user U1 (father) uses a mobile terminal apparatus 1A as a first terminal, and the second user U2 (mother) uses a mobile terminal apparatus 1B as a second terminal.

The autonomous vehicle 2 includes the in-vehicle apparatus 200 and the like. The in-vehicle apparatus 200 of the autonomous vehicle 2 is any apparatus, but is, for example, an electronic control unit (ECU) or an apparatus connected thereto although not illustrated. The ECU is a unit that performs control for the autonomous driving or the like, including control for an engine, an accelerator, and a brake. The in-vehicle apparatus 200 may include a car navigation system, a head-up display (HUD) or the like.

In this example, the in-vehicle apparatus 200 is configured to include a display screen with a touch panel 201 or the like, a hardware button, an audio (sound) input/output portion including a microphone, a loudspeaker and the like not illustrated, a sensor 202 including a camera, various sensors, and the like. For example, the touch panel 201 is placed in a dashboard. A display screen of the touch panel 201 displays information regarding a graphical user interface (GUI) and the like related to the autonomous vehicle 2. The user can perform an input through a touch operation on the screen of the touch panel 201. The sensor 202 is placed in, for example, a roof portion on the upper side of a windshield. The sensor 202 may capture an image of the outside and the inside of the vehicle and measure the outside and the inside by using, for example, a camera or a ranging (distance measurement) sensor to detect a surrounding state of the vehicle and a state of the occupant. For example, the sensor 202 may detect whether or not the occupant exists in the vehicle, detect riding and exiting, detect a riding position, or the like. The sensor 202 may detect an arousal/sleep state, a direction of a line of sight or the like, on the basis of a state of occupant's eyes or the like.

The audio input/output portion may have a function of recognizing an audio input from the microphone as a predetermined operation instruction audio, or may output a predetermined guidance audio or the like from the loudspeaker through audio synthesis.

Any in-vehicle apparatus 200 of the autonomous vehicle 2, specifically, the touch panel 201, the sensor 202, and the like may cooperate with the mobile terminal apparatus 1 through communication, or a communication portion (a portion including a wireless communication interface such as a wireless communication antenna or a circuit) or another portion not illustrated may cooperate therewith.

In each of the mobile terminal apparatuses 1, a screen (an operation menu screen or the like described later) enabling the cooperation of the operation instruction to the autonomous vehicle 2 or the like is displayed on a screen of the touch panel 201 of the terminal itself to receive the input operation performed by the user. Each of the mobile terminal apparatuses 1 determines whether or not the terminal itself (or the corresponding user) has the operation privilege, on the basis of the setting information 11, the inter-terminal communication 12, and the like. Each of the mobile terminal apparatus 1 appropriately performs communication such as the inter-terminal communication 12 with the other mobile terminal apparatus 1. If the terminal itself has the operation privilege, the mobile terminal apparatuses 1 transmits the operation instruction 13 (or the corresponding operation instruction information) through communication to the in-vehicle apparatus 200, on the basis of the input operation on the screen performed by the user.

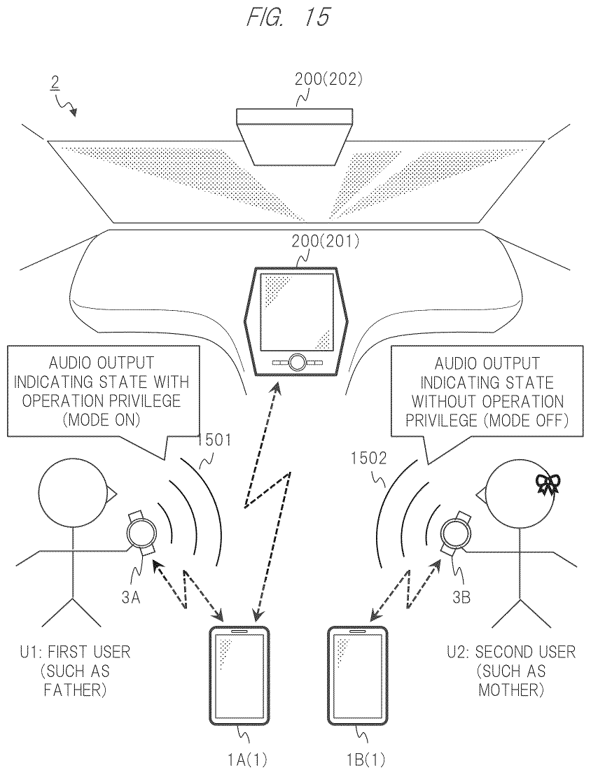

The mobile terminal apparatus 1 is not limited to the smartphone, but may be, for example, a wearable terminal that can be attached to an arm or a head. As the wearable terminal, a smartwatch, smartglasses, a head-mounted display (HMD) and the like are exemplified. In an example illustrated in FIG. 15 described later, a predetermined audio is output from the wearable terminal that cooperates with the smartphone.

In an example illustrated in FIG. 1, the same setting information 11 is previously set in the respective mobile terminal apparatus 1 (1A and 1B) of the users. Information including information about the users (U1 and U2) making the group and respective rankings (ranking information) of the users of the group is set as the setting information 11. In this example, the ranking of the father is set to 1, and the ranking of the mother is set to 2. In the first embodiment, only one of the users of the group is basically determined to have the operation privilege.

The mobile terminal apparatus 1 of each user detects the other user terminals of the group by performing the inter-terminal communication 12 via a predetermined near field communication interface. If detecting the other user terminal of the group, the mobile terminal apparatus 1 of each user determines whether to have the operation privilege, on the basis of the setting information 11 (particularly the ranking information). The detected user terminals including the terminal itself are set to the candidate user terminals, and the user terminal having the highest ranking among the candidate user terminals is determined to have the operation privilege.

In the example illustrated in FIG. 1, at one time, on the basis of the inter-terminal communication 12 and the setting information 11 between the terminal 1A of the first user U1 (father) and the terminal 1B of the second user U2 (mother), it is determined that the terminal 1A of the first user U1 as the father has the operation privilege on this autonomous vehicle 2. In this state, the terminal 1B of the second user U2 as the mother does not have the operation privilege. The father has a higher ranking than that of the mother on the basis of the ranking information, and therefore, it is determined that the terminal 1A of the first user U1 as the father has the operation privilege.

After the operation privilege is determined, in the state illustrated in FIG. 1, the operation instruction 13 to the autonomous vehicle 2 can be transmitted from the terminal 1A to the in-vehicle apparatus 200 on the basis of the input operation on the screen of the terminal 1A performed by the first user U1 having the operation privilege. The terminal 1B of the second user U2 does not have the operation privilege, and therefore, cannot transmit the operation instruction 13 to the in-vehicle apparatus 200.

In the example illustrated in FIG. 1, if two persons that are the father and the mother ride on the vehicle or if only the father rides thereon, the terminal 1A of the father has the operation privilege because the father has the highest ranking based on the ranking information. Further, if only the mother rides thereon, for example, the terminal 1B of the mother has the operation privilege because the mother has the highest ranking.

### [Processing Example]

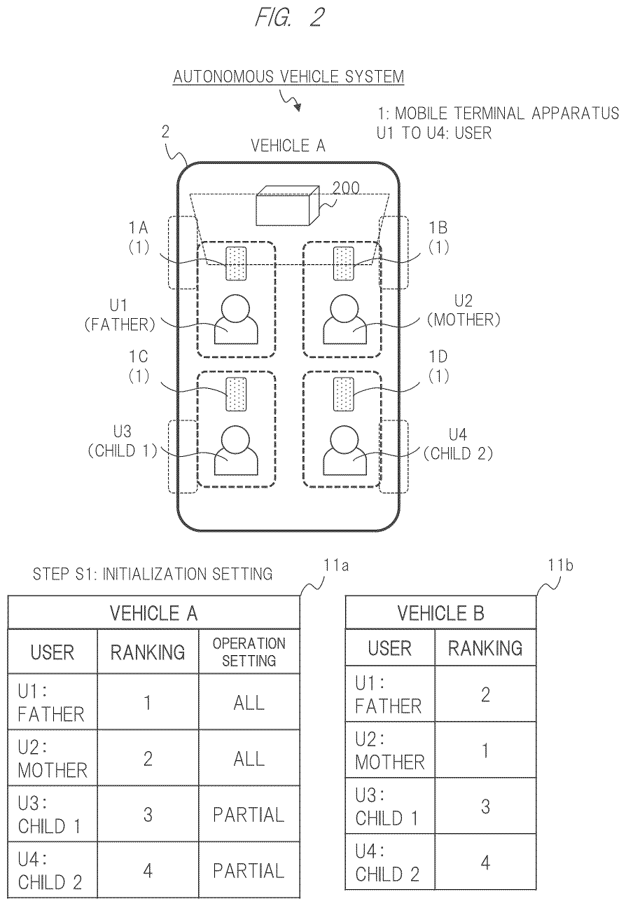

FIGS. 2 to 4 illustrate a processing example in the first embodiment corresponding to the outline of FIG. 1, and schematically include steps S1 to S4 as processing steps related to the cooperative function as a characteristic function. FIGS. 2 to 4 each illustrate a case where a vehicle A as a specific vehicle is used by a specific group (such as a family).

FIG. 2 illustrates a schematic view in a case where four users (U1 to U4) of the group as the family ride on the vehicle A, and initialization setting in step S1. The users (U1 to U4) respectively carry their own mobile terminal apparatuses 1 (1A to 1D). The first user U1 as the father has the terminal 1A, the second user U2 as the mother has the terminal 1B, the third user U3 as a child (first child) has a terminal 1C, and the fourth user U4 as a child (second child) has a terminal 1D.

In FIG. 2, as an example of the initialization setting in step S1, the user terminals (1A to 1D) have the same setting information 11a. The setting information 11a includes information about the specific vehicle to be used (the “vehicle A” in this example), information (U1 to U4 as user IDs in this example) about the user terminals making the group as the use candidates, ranking information, and operation setting information.

As a modification example, note that the setting information may be set and stored in the in-vehicle apparatus 200, an external server, or the like, and each of the user terminals appropriately refers to and acquires the setting information.

As the ranking information in this example, numerical values of rankings are respectively set to 1, 2, 3, and 4 for the users U1, U2, U3, and U4. The operation setting information is information for setting the operation instruction (or a corresponding operation item) to be allowed if the operation privilege is given to each user although described later. In this example, the users U1 and U2 are each set to “ALL”, and the users U3 and U4 are each set to “Partial”. “All” means that all of operation instructions that can be issued to the in-vehicle apparatus 200 are allowed. “Partial” means that a specific part of the operation instructions that can be issued to the in-vehicle apparatus 200 are allowed. The specific part of the operation instructions is previously defined, or an individual operation to be allowed for each user can be specifically set. Note that the operation setting information may be eliminated from the setting information so that the operation instructions in a previously defined range are allowed for all the users.

If the setting information 11 is set in any one of the user terminals or if the setting information 11 is updated, note that the user terminals 1 of the group communicate with one another for synchronizing the latest setting information such that each of the user terminals of the group have the same setting information as the latest setting information of the user terminal.

As setting information 11b, an example in which a content is updated from that of the setting information 11a is described. In the setting information 11b, the rankings are changed, and the numerical values of the rankings are respectively set to 2, 1, 3, and 4 for the users U1, U2, U3, and U4.

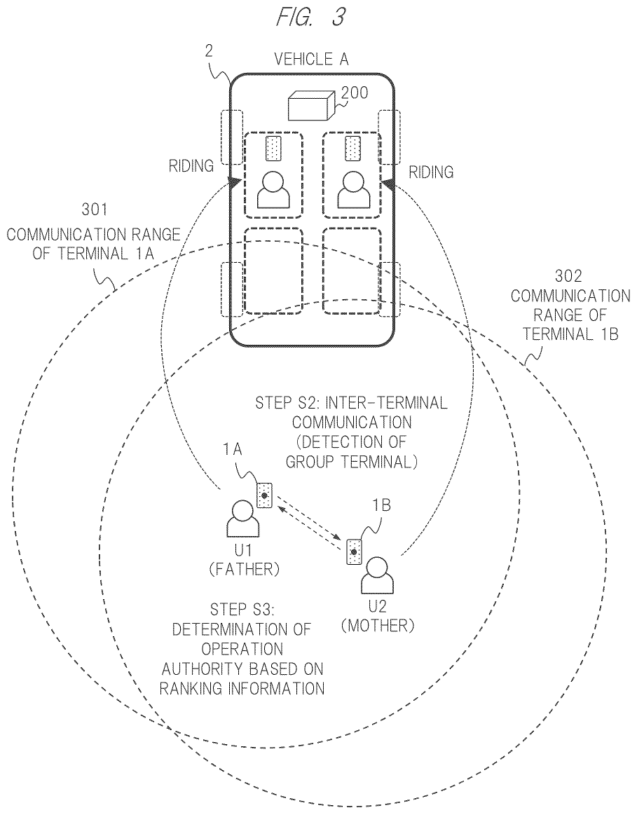

FIG. 3 illustrates an explanatory diagram in a case where the operation privilege is determined when, for example, the father (U1) and the mother (U2) among the users of the group illustrated in FIG. 2 use and ride on the vehicle A, on the basis of the inter-terminal communication 12 and the setting information 11a (particularly regarding the ranking). FIG. 3 includes the inter-terminal communication 12 as step S2 and the determination of the operation privilege as step S3. In step S2, each of the user terminals (the terminals 1A and 1B in this example) detects the other user terminal (group terminals) of the group via the inter-terminal communication 12 using a predetermined near field communication interface. In this example, the terminal 1A of the father (U1) and the terminal 1B of the mother (U2) are near the vehicle A. A dashed circle schematically indicates a communication range using the predetermined near field communication interface. The terminal 1A of the father (U1) has a communication range 301, and the terminal 1B of the mother (U2) has a communication range 302. Note that this communication range may actually be wider. The terminal 1B of the mother (U2) is also within the communication range 301. The terminal 1A of the father (U1) is also within the communication range 302. Accordingly, in this example, the terminal 1A of the father (U1) detects the terminal 1B of the mother (U2) while the terminal 1B of the mother (U2) detects the terminal 1A of the father (U1) through the inter-terminal communication 12.

In step S3, each of the user terminals (1A and 1B) determines whether or not the terminal itself has the operation privilege, on the basis of the ranking information of the setting information 11a (step S1). Each of the user terminals compares the terminal itself and the other user terminals detected in step S2 as candidates to each other to determine that the user terminal having the highest ranking has the operation privilege. More specifically, each of the user terminals may compares the rankings for each of the detected counterpart user terminals to only determine whether or not the terminal itself has the operation privilege. By the comparison between the ranking of the terminal itself and the ranking of the detected counterpart user terminal, it is determined that the terminal itself has the operation privilege if the ranking of the terminal itself is higher, or it is determined that the terminal itself does not have the operation privilege if the ranking of the terminal itself is lower. Note that the state with the operation privilege corresponds to a mode-ON state described later while a state without the operation privilege corresponds to a mode-OFF state described later. In this example, the ranking of the father (U1) is higher than that of the mother (U2) in a relation of the terminal 1A of the father (U1) and the terminal 1B of the mother (U2). Accordingly, the terminal 1A of the father (U1) has the operation privilege while the terminal 1B of the mother (U2) does not have the operation privilege.

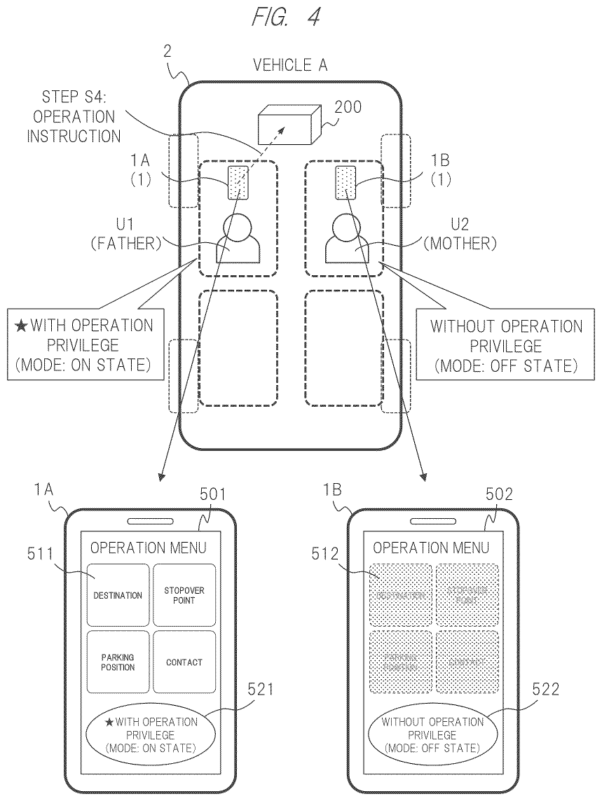

Following FIG. 3, FIG. 4 illustrates a case where the terminal 1A of the father (U1) having the operation privilege transmits the operation instruction 13 to the in-vehicle apparatus 200 while the father (U1) and the mother (U2) are riding on the vehicle A. FIG. 4 includes provision of a screen corresponding to the operation privilege and the mode state for each of the user terminals and the transmission of the operation instruction 13 as step S4. The first embodiment includes a control mode (such as a “cooperative mode”) to turn the mode into the ON state in the case of the state with the operation privilege, or into the OFF state in the case of the state without the operation privilege.

The mode of the terminal 1A of the father (U1) is turned to the mode-ON state because of having the operation privilege, and the mode of the terminal 1B of the mother (U2) is turned to the mode-OFF state because of not having the operation privilege. If the mode of the user terminal has changed from the mode OFF state to the mode ON state because of the state with the operation privilege (or at a timing for each of the determinations in step S3), the user terminal may perform a predetermined output for notifying the user that the mode has been turned to the mode ON state. Although described later, this output may be, for example, a predetermined screen display, light emission, or vibration, or may be a predetermined audio output. For example, the ON-state terminal 1A of the father outputs the predetermined audio. For example, the terminal 1A of the father (U1) outputs the predetermined audio at the time of the mode ON state after step S3. Because of this output, the father (U1) can understandably recognize that he and the terminal 1A have the operation privilege. The mother (U2) near the father (U1) can also understandably recognize that the father (U1) and the terminal 1A have the operation privilege.

As a modification example, the predetermined output for making the notification regarding the operation privilege and the mode state may be an output from the in-vehicle apparatus 200. That is, for example, the instruction is transmitted from the mobile terminal apparatus 1 to the in-vehicle apparatus 200 that cooperate with each other, and the in-vehicle apparatus 200 (such as the touch panel 201) performs the predetermined output. Further, in this case, by the in-vehicle apparatus 200, the state (particularly the state with/without the operation privilege) of each of the occupants in the vehicle may be displayed with an icon or the like.

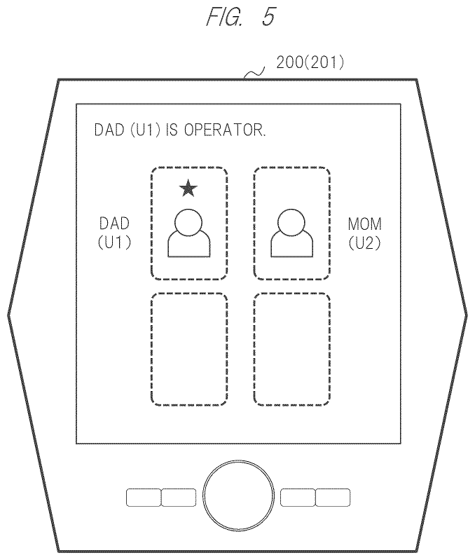

In an example illustrated in FIG. 5, on the screen of the touch panel 201 of the in-vehicle apparatus 200, a state of an arrangement of an occupant (user) corresponding to a seat of the vehicle A and the state with/without the operation privilege related to the cooperative function are graphically displayed with the icon or the like. Further, a similar display to this may be performed on a screen of the mobile terminal apparatus 1.

A lower part of FIG. 4 illustrates a display example of the operation menu screen related to the cooperative function in each of the user terminals (1A and 1B) of the father (U1) and the mother (U2), and the example includes an operation menu screen 501 of the mode-ON terminal 1A of the father (U1) and an operation menu screen 502 of the mode-OFF terminal 1B of the mother (U2). Each of the operation menu screens 501 and 502 includes a plurality of (such as four) operation items. Each of the operation items is normally displayed if the operation item can be operated for the instruction or is displayed with, for example, a gray color if the operation item cannot be operated for the instruction. In this example, all operation items 511 of the terminal 1A of the father (U1) are normally displayed because it has the operation privilege, and all operation items 512 of the terminal 1B of the mother (U2) are displayed with the gray color because it does not have the operation privilege.

Further, on the operation menu screen of each of the user terminals, a display representing the operation privilege and the mode state may be performed. For example, the operation menu screen 501 of the terminal 1A of the father (U1) includes a display 521 for indicating the state with the operation privilege and the mode ON state, and the operation menu screen 502 of the terminal 1B of the mother (U2) includes a display 522 for indicating the state without the operation privilege and the mode OFF state. Note that such displays and audio outputs are not essential.

In step S4, the father (U1) having the operation privilege looks at the operation menu screen 501 of the mode-ON terminal 1A, to select the desired operation item 511 and perform the input operation (such as a touch). As a result, the terminal 1A transmits the operation instruction 13 (a command corresponding thereto) corresponding to the operation item 511 to the in-vehicle apparatus 200 (the ECU in the first embodiment). The in-vehicle apparatus 200 performs autonomous driving control of the vehicle A or the like in accordance with the received operation instruction 13. The terminal 1B of the mother (U2) is in the mode OFF state, and therefore, cannot transmit the operation instruction 13 even if the input operation has been performed to the operation item 512 displayed with the gray color.

### [Mobile Terminal Apparatus]

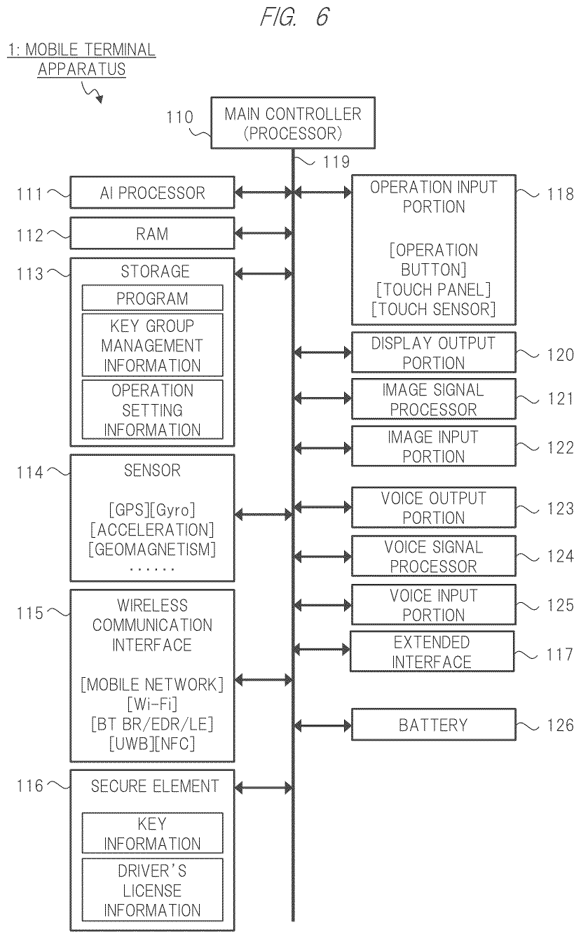

FIG. 6 illustrates a functional block configuration example of the mobile terminal apparatus 1. The mobile terminal apparatus 1 is configured to include a main controller 110, an AI processor 111, a RAM 112, a storage 113, a sensor 114, a wireless communication interface 115, a secure element 116, an extended interface 117, an operation input portion 118, a display output portion 120, an image signal processor 121, an image input portion 122, an audio output portion 123, an audio signal processor 124, an audio input portion 125, a battery 126, and the like. These portions are connected to one another via a bus 119, and can each transmit/receive data and information as input/output.

The main controller 101 is made of a processor, a memory, and the like, and is equivalent to a controller that controls the entire mobile terminal apparatus 1 and each of its portions. The AI processor 111 is a portion that performs inference and learning processing related to, for example, face recognition, fingerprint recognition, audio recognition, and context recognition as artificial intelligence (AI) processing. A storage region of a storage such as the RAM 112 or the storage 113 stores a program and various types of data and information. A non-volatile storage such as the storage 113 stores setting information such as key group management information and operation setting information described later.

The sensor 114 is a portion including various types of sensors such as a GPS receiver, a gyroscopic sensor, an acceleration sensor, a geomagnetic sensor, a proximity sensor, an environment sensor, and a LiDAR. By the sensor 114, states such as a position and a posture (orientation) of the mobile terminal apparatus 1 can be acquired.

The wireless communication interface 115 is a portion including an antenna, a circuit and the like on which a predetermined communication interface such as a mobile network, the Internet, Wi-Fi (registered trademark), Bluetooth (registered trademark), a UWB, and an NFC. The extended interface 117 is a portion such as a USB interface. The wireless communication interface 115 includes a near field communication interface used for the inter-terminal communication 12.

The secure element 116 is a portion that securely stores data and information requiring a high confidentiality when being handled, and includes a predetermined mechanism such as a cipher (encryption) for ensuring a security. As the data and the information to be stored in the secure element 116, for example, a digitized vehicle key (key information of a specific vehicle), driver's license information, automobile insurance certificate information, credit card information, other types of identity verification certificate information and the like are exemplified. The secure element 116 performs necessary processing related to such information, such as processing for reading, writing, and transaction control. The secure element 116 may be mainly mounted as a hardware mounting or a software mounting.

The operation input portion 118 is a portion enabling the user to perform the operation input and including an operation button, a touch panel, a touch sensor, and the like based on the hardware. Note that the touch panel and the touch sensor may be unified with each other. The operation input portion 118 may include the fingerprint sensor or the like as the touch sensor. The touch panel and the touch sensor are each a portion enabling the display and the operation input, and can be mounted by, for example, a touch panel module based on a liquid crystal or an organic EL.

The image input portion 122 is a portion that inputs data such as an image. The image signal processor 121 is a portion that performs processing such as generation of an image signal on the basis of the data such as the image. The display output portion 120 is a display that displays an image and a video image on the basis of the image signal or the like, and may be a display on a screen of the touch panel. The audio input portion 125 is a portion that includes a microphone and inputs the audio as audio data. The audio signal processor 124 is a portion that performs processing such as generation of an audio signal on the basis of the audio data. The audio output portion 123 is a portion that includes a loudspeaker and outputs the audio on the basis of the audio signal. The extended interface 117 is, for example, a USB interface, and receives a charge and a data input/output. The battery 126 supplies power to each of the portions.

A specific function in the embodiment is also described as a cooperative function. The cooperative function is a function of enabling the operation instruction from the mobile terminal apparatus 1 of the user to the in-vehicle apparatus 200 of the autonomous vehicle 2 through cooperation of communication or the like. As one of programs, the mobile terminal apparatus 1 includes an application software (application program) related to the cooperative function or the like. The mobile terminal apparatus 1 provides a screen serving as a GUI to the user by using the application software.

### [Processing Flow]

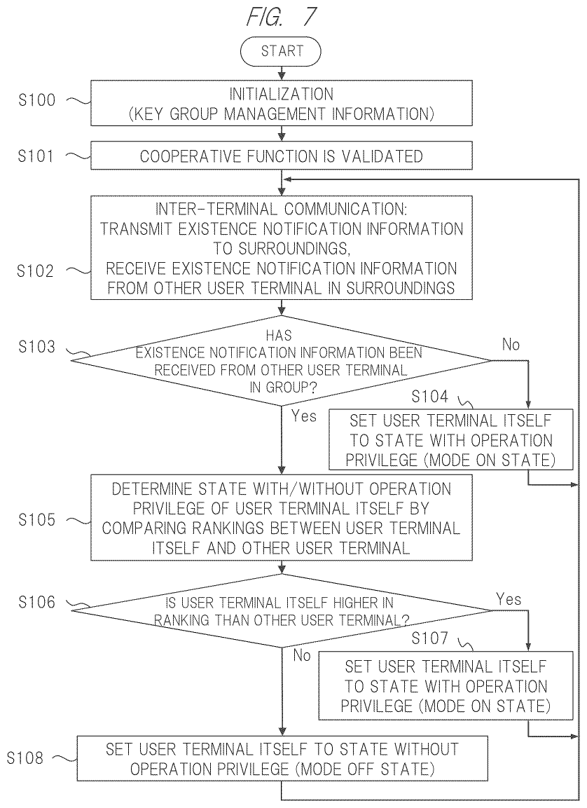

FIG. 7 illustrates a main processing flow in the mobile terminal apparatus 1 in the first embodiment. This processing flow is common among the user terminals of the group, and includes steps S100 to S108. In this processing flow, a control mode related to the cooperative function is provided such that the state with the operation privilege is corresponded to the mode ON state while the state without the operation privilege is corresponded to the mode OFF state. This processing flow includes a step (step S2 in FIG. 3) of detection of a user terminal of a key group described later through the inter-terminal communication 12 and a step (step S3) of determination of the operation privilege based on the ranking information.

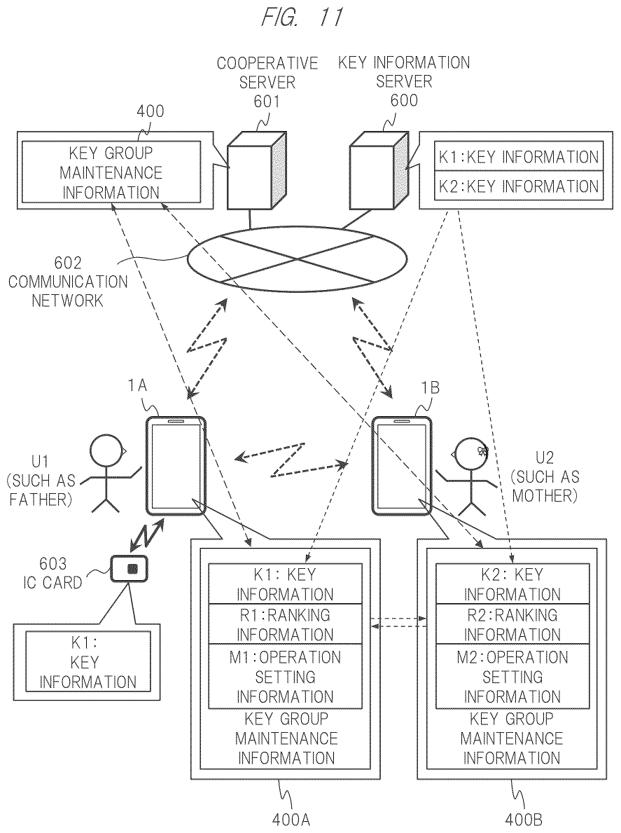

In step S100, each of user terminals of the group (such as family) performs initialization setting (including synchronous communication), and stores the setting information 11 (FIG. 1 or 2). In the first embodiment, this initialization setting is a setting of the key group management information 400 in FIG. 9 described later as the setting information 11. The key group management information 400 includes the ranking information described above, and the like. The synchronous communication in the initialization setting information can be achieved by, for example, registering the initialization setting information onto the terminal 1A of the father (U1), and then, transmitting the same setting information to other user terminals (such as terminals of the mother and the child) of the group from the terminal 1A, and registering the same setting information onto each of the group terminals. As another setting method, the initialization setting information may be registered from a certain user terminal onto an external apparatus such as a cooperative server 601 illustrated in FIG. 11 described later, and then, the initialization setting information may be transmitted from the server to other user terminals of the group for the purpose of synchronization.

In step S101, when each of the user terminals uses the cooperative function, the cooperative function in each terminal itself is set to change from an invalid state to a valid state. Note that the validation/invalidation of this cooperative function is made different from the ON/OFF of the mode. For example, as one of user settings, this cooperative function may be previously set to the valid state through a setting screen achieved by an application software related to the cooperative function of the mobile terminal apparatus 1. Alternatively, the user may appropriately input an instruction to set the cooperative function to the valid state. In a modification example, in the mobile terminal apparatus 1, the cooperative function may be set to the valid state by a predetermined automatic determination. As the predetermined determination, determination of whether or not the terminal itself has sufficiently approached the specific vehicle is exemplified (in a modification example described later). If the cooperative function is set to the invalid state, note that the transmission of the operation instruction 13 or the like cannot be performed.

In step S102, each of the user terminals performs the inter-terminal communication 12 (step S2 in FIG. 3) via a predetermined near field communication interface. The mobile terminal apparatus 1 transmits existence notification information to surroundings repeatedly at a predetermined time interval within a predetermined communication range corresponding to the predetermined near field communication interface. This transmission may be set as, for example, a broadcast in Bluetooth (registered trademark). The existence notification information is information for notifying the surroundings of the existence of the terminal itself and information for detecting the existence of the other terminal (group terminal) in the surroundings. The existence notification information is information enabling confirmation and identification of whether or not the terminal is the user terminal of the key group. The existence notification information includes information enabling the user terminal as the terminal itself of the group to be identified and determined. The existence notification information includes at least the information registered in the key group management information 400 illustrated in FIG. 9, such as a vehicle ID (or a group ID), a user ID (or a terminal ID), or a key information hash value.

In step S102, at the same time, each of the user terminals waits for the existence notification information from the other user terminal. On the basis of information about a content of the existence notification information and the key group management information 400, the user terminal that has received the existence notification information identifies the counterpart user terminal (group terminal) that has transmitted the existence notification information.

For example, when receiving the existence notification information, each of the user terminals confirms whether or not the user terminal (a user ID, a terminal ID, or a communication address, etc.) that is a transmission source of the existence notification information matches the other user terminal (a user ID, a terminal ID, or a communication address, etc.) of the group (that is a group having the same vehicle ID) registered in the key group management information 400 of the terminal itself. When the user terminals match each other, this indicates that the counterpart user terminal is the group terminal.

If receiving the existence notification information and confirming that the counterpart user terminal is the group terminal, the user terminal may transmit a predetermined response to the counterpart group terminal. If receiving the existence notification information and determining that the counterpart user terminal is not the group terminal, the user terminal may not transmit the response thereto.

Thus, by the inter-terminal communication 12 in which the existence notification information is transmitted among the user terminals, the other user terminal (group terminal) that shares the key group management information 400 (particularly the ranking information) of the specific vehicle can be detected. Note that the example illustrated in FIG. 3 show only two members. However, each of the user terminals may simultaneously receive the existence notification information from the plurality of user terminals.

Note that the transmission and the reception of the existence notification information in step S102 are not limited to the broadcast, but may be one-to-one link communication after the user terminals of the group are previously set to be communicable with each other (such as address registration). When receiving the existence notification information from the other user terminal of the group (group terminal), the user terminal may establish a connection through the one-to-one link communication with the group terminal. Then, the user terminal may use the link communication for control related to the cooperative function while always monitoring the link communication. Alternatively, for example, if the link communication with all the other user terminals of the group is established, the user terminal may stop transmitting the existence notification information thereto. The above-described one-to-one link communication is communication in which a predetermined security level is ensured by encryption or the like via a predetermined communication interface (such as Bluetooth).

Step S103 is a step of determining a result of step S102, and is a branch step depending on whether or not the existence notification information from the other user terminal of the group (group terminal) has been received, in other words, whether or not the group terminal has been detected. The processing proceeds to step S105 if the existence notification information has been received (Yes), or proceeds to step S104 if the existence notification information has not been received (No).

In step S104, only the terminal itself exists as the user terminal, and therefore, is set to the mode ON state as the state with the operation privilege. Then, the processing returns to step S102, and is similarly repeated.

In step S105, the terminal itself and one or more counterpart group terminals detected exist as the user terminals, and it is determined whether or not the user terminals serving as the candidate user terminals have the operation privilege related to the cooperative function. The user terminals refer to the ranking information in the key group management information 400, and the ranking is compared among the candidate user terminals. In the user terminals, it is determined that the terminal itself has the operation privilege if the terminal itself has a higher ranking than those of the other user terminals, or it is determined that the terminal itself has no operation privilege if the other user terminals have a higher ranking than that of the terminal itself.

Step S106 is a branch step depending on a result of step S105. If the terminal itself has a higher ranking than those of the other user terminals (Yes), in other words, if the terminal itself has the highest ranking among the candidate user terminals, the processing proceeds to step S107. If the user terminal itself has a lower ranking than those of the other user terminal (No), the processing proceeds to step S108.

In step S107, since the terminal itself serving as the user terminal has the operation privilege, the terminal itself is set to the ON state. If the terminal itself has already been in the ON state, note that the ON state is maintained. Then, the processing returns to step S102, and the processing is similarly repeated.

In step S108, since the terminal itself serving as the user terminal has no operation privilege, the terminal itself is set to the OFF state. If the terminal itself has already been in the OFF state, note that the OFF state is maintained. Then, the processing returns to step S102, and the processing is similarly repeated.

Note that the following process steps may be added to the flow (such as the step S102) illustrated in FIG. 7. On the basis of transmission and reception (or link communication) of the existence notification information, the user terminal determines whether or not no group terminal has existed in the surroundings (within the predetermined communication range). For example, if having received the existence notification information once from a certain group terminal, and then, having not received the existence notification information from this group terminal or the link communication has been disconnected after an elapse of a certain time period, the user terminal can determine that this group terminal has separated and disappeared from the surroundings (from the predetermined communication range). Alternatively, the user terminal may explicitly receive a notification of the link communication end from the group terminal.

In the case, the user terminal excludes the disappeared group terminal from among the candidate user terminals, and re-performs the determination of the operation privilege in step S105 or the like among the currently-existing candidate user terminals. For example, if only the terminal itself has existed as the candidate user terminal, the terminal itself is set to the mode ON state.

Further, the flow of FIG. 7 is ended by a predetermined trigger. The trigger may be, for example, an input operation of inputting an instruction to bring the cooperative function into the invalid state or an instruction to end the application software performed appropriately by the user. Alternatively, in a modification example, the user terminal may bring the cooperative function into the invalid state or the end state by a predetermined automatic determination of determining whether or not the terminal itself serving as the user terminal has sufficiently separated from the specific vehicle.

As described above, in an example of the processing flow illustrated in FIG. 7, the operation privilege can be basically determined only by the comparison in the ranking between the terminal itself and the other user terminals, and the operation privilege changes depending on the surrounding state. For example, in the example illustrated in FIG. 1 or the like, if the father (U1) further separates from the vehicle A, the candidate user terminal is only the terminal 1B of the mother (U2), and the mother (U2) has the highest ranking, and therefore, a state where the terminal 1B of the mother (U2) has the operation privilege is provided. In the first embodiment, from a bird's-eye view of the whole, at the time of the usage of the specific vehicle, only one terminal of the plurality of user terminals of the group is set to the mode ON state while all the other user terminals are set to the mode OFF state on the basis of the ranking information.

### [Existence Notification Information]

In the communication for the existence notification information in step S102, note that a method for encryption, scrambling, or the like may be applied to enhance the security. Further, the communication for the existence notification information may include, for example, exchange of a confirmation code. The confirmation code can be exchanged, for example, as follows. The user terminal transmits a confirmation-code return request to the surroundings when desiring to confirm the existence and the validity of the group terminal, and confirms the existence and the validity of the group terminal when receiving a confirmation-code return response from the other user terminal that has received this request. This exchange is on the premise that the communication between the user terminals of the group is a snooping communication, a broadcasting communication, or a multicasting communication. The confirmation code may be information generated by, for example, a random number.

As an example of the communication, one of the user terminals first transmits the existence notification information, the confirmation code, and the confirmation-code return request to the surroundings. When receiving the existence notification information or the like, the other user terminal transmits the confirmation-code return response accompanied by the confirmation code toward the one user terminal. One of the user terminals determines the confirmation code of the confirmation-code return response received from the other user terminal, and confirms that the other user terminal is the group terminal.

As described above, the terminal itself and the counterpart user terminal can be mutually confirmed to be respectively the group terminals because of confirming each other by using the existence notification information. The validity of the terminal itself can be demonstrated by the return of the predetermined response to the counterpart user terminal. In other words, the validity can be confirmed among the transmission terminals by at least two different request-response handshakes (a request from a first terminal to a second terminal and a response from the second terminal to the first terminal and a request from the second terminal to the first terminal and a response from the first terminal to the second terminal). Although a case of the two user terminals is described in the above-described example, the same applies to a case of three or more user terminals.

For example, when four user terminals A to D exist near one another, a request (the broadcast of the existence notification information) is transmitted from the user terminal A to the user terminals B, C, and D, and the respective responses (the broadcasts of the existence notification information) are received by the user terminal A. As a result, the user terminal A can confirm the respective validities of the user terminals B, C, and D. The user terminal B transmits a request to the user terminal A while the user terminal A transmits a response to the user terminal B. As a result, the user terminal B can confirm the validity of the user terminal A. Further, the user terminal B can receive and confirm the respective responses from the user terminals C and D to the user terminal A. Accordingly, the confirmation of the respective validities of the user terminals C and D (the confirmation of the transmission of the respective requests to the user terminals C and D and the respective responses from the user terminals C and D) can be omitted.

### [Processing Sequence Example]

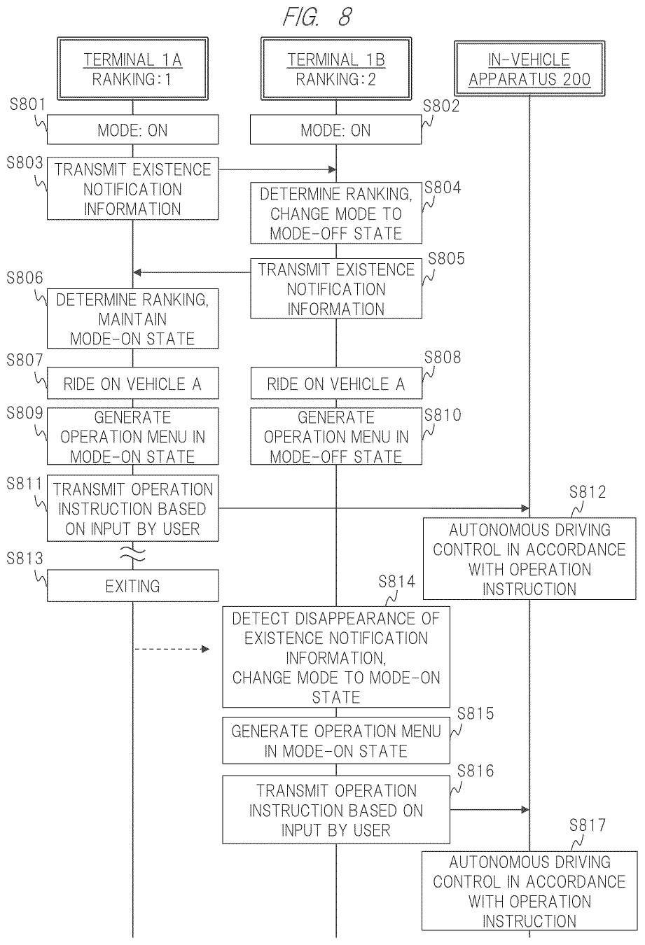

FIG. 8 illustrates an example of a processing sequence including a step of determining the operation privilege among the terminal 1A of the user U1 (father), the terminal 1B of the user U2 (mother) and the in-vehicle apparatus 200 of the vehicle A illustrated in FIG. 1 as corresponding to FIG. 7. In this example, the rankings of the father and the mother in the setting information 11 are 1 and 2, respectively. First, the terminal 1A of the father and the terminal 1B of the mother are each in a state where the father and the mother have not ridden on the vehicle A.

In step S801, the terminal 1A of the father is set to the ON state as the initial mode state. The “initial” state is a state where it has not yet been determined whether or not the group terminal exists in the surroundings. Similarly, in step S802, the terminal 1B is set to the ON state as the initial mode state.

In step S803, as the inter-terminal communication 12, the terminal 1A of the father transmits the existence notification information to the surroundings. In this example, the terminal 1B exists within the predetermined distance range of the terminal 1A (as similar to FIG. 3). Accordingly, the terminal 1B of the mother receives the existence notification information. In step S804, the terminal 1B of the mother refers to the ranking information of the key group management information 400 or the like on the basis of the existence notification information, compares the ranking between the terminal itself and the counterpart terminal, and determines whether or not the terminal itself has the operation privilege. In this example, the ranking of the terminal itself is 2 while and the ranking of the counterpart terminal is 1. Accordingly, the terminal 1B that is the terminal itself does not have the operation privilege. Accordingly, the mode of the terminal 1B is changed from the ON state to the OFF state.

In step S805, the terminal 1B of the mother transmits the existence notification information to the surroundings. In this example, the terminal 1A exists within the predetermined distance range of the terminal 1B (as similar to FIG. 3). Accordingly, the terminal 1A of the father receives the existence notification information. In step S806, the terminal 1A of the father refers to the ranking information of the key group management information 400 or the like on the basis of the existence notification information, compares the ranking between the terminal itself and the counterpart terminal, and determines whether or not the terminal itself has the operation privilege. In this example, the ranking of the terminal itself is 1 while the ranking of the counterpart terminal is 2. Accordingly, the terminal 1A that is the terminal itself has the operation privilege. Accordingly, the mode of the terminal 1A is maintained in the ON state.

Steps S807 and S808 indicate an operation in a case where the users (U1 and U2) have ridden on the vehicle A. In this case, by using the sensor, the autonomous vehicle 2 or the mobile terminal apparatus 1 may detect a state in which the user has ridden or not ridden on the vehicle. For example, the autonomous vehicle 2 may detect that the user has been seated in a seat. In the case, the in-vehicle apparatus 200 may notify the mobile terminal apparatus 1 that the seating has been detected.

In step S809, the terminal 1A of the father (U1) generates and displays an operation menu screen in accordance with the detection of the riding, the input operation performed by the user U1 or the like. At this time, the terminal 1A of the father is in the mode ON state with the operation privilege. Accordingly, this operation menu screen is generated and displayed as an operation menu screen corresponding to the mode ON state where all predetermined operation instructions are enabled, as similar to FIG. 4.

In step S810, the terminal 1B of the mother (U2) generates and displays an operation menu screen in accordance with the detection of the riding, the input operation performed by the user U2 or the like. At this time, the terminal 1B of the mother is in the mode OFF state without the operation privilege. Accordingly, this operation menu screen is generated and displayed as an operation menu screen corresponding to the mode OFF state where all predetermined operation instructions are disabled, as similar to FIG. 4.

In a modification example described later, note that the operation privilege can limited such that some of operation instructions are enabled in the mode ON state with the operation privilege in accordance with a setting for each user. In the case, an operation menu screen where some of the operation instructions are enabled is generated and displayed.

In step S811, the terminal 1A of the father (U1) generates operation instruction information (such as a command) corresponding to the operation instruction 13 and transmits the operation instruction information to the in-vehicle apparatus 200 on the basis of the input operation (such as pressing of a button for the operation item) on the operation menu screen in the mode ON state performed by the user U1. The in-vehicle apparatus 200 receives the operation instruction information. In step S812, the in-vehicle apparatus 200 performs the autonomous driving control or the like to the autonomous vehicle 2 in accordance with the operation instruction information. If the operation instruction is for, for example, an item “destination”, the in-vehicle apparatus 200 controls the autonomous driving for a designated designation.

Then, step S813 shows an operation in a case where the father (U1) has exited from the vehicle A. In step S814, the terminal 1B of the mother (U2) detects and determines the disappearance of the existence notification information transmitted from the terminal 1A of the father (U1), and regards the disappearance as the exiting of the father (U1) therefrom. When the terminal 1A of the father (U1) separates from a position of the terminal 1B of the mother (U2), the existence notification information transmitted from the terminal 1A of the father (U1) is out of the communication range 302 of the terminal 1B of the mother (U2) (FIG. 3), and does not reach the terminal 1B. The terminal 1B of the mother (U2) determines that, for example, only the terminal itself exists as the candidate user terminal and has the highest ranking, and therefore, determines that the terminal itself has the operation privilege, and its mode is changed from the OFF state to the ON state.

In step S815, the terminal 1B of the mother (U2) generates the operation menu screen corresponding to the mode ON state, and updates the display. The operation menu screen at this time is a screen having a content where all operation instructions are enabled. In step S816, the terminal 1B of the mother (U2) transmits the operation instruction information to the in-vehicle apparatus 200 on the basis of the input operation on the operation menu screen corresponding to the mode ON state performed by the user U2. The in-vehicle apparatus 200 receives the operation instruction information. In step S817, the in-vehicle apparatus 200 performs the autonomous driving control and the like in accordance with the operation instruction information.

### [Key Group Management Information]

FIG. 9 illustrates a configuration example of the key group management information 400 as one of the initialization setting information. A table of the key group management information 400 illustrated in FIG. 9 includes “vehicle ID” for identifying and determining the autonomous vehicle 2 as the specific vehicle to be a target used by the plurality of users of the group (=key group) and information about each of the user terminals (group terminals) of the group set for the “vehicle ID”. As the information about the group terminal, this table includes “key information (key number/hash value)”, “user ID”, “operation setting”, “operation ranking”, “display name”, and the like illustrated as the items corresponding to columns. Each of the plurality of user terminals of the key group has the key information for using the target autonomous vehicle 2.

The item “User ID” is information for identifying the user having the key information, and may be information for identifying the mobile terminal apparatus 1 or the like. The item “Display name” is setting information used for roughly identifying and displaying each user on the screen of the mobile terminal apparatus 1 or the like. In this example, the father (“dad”), the mother (“mom”), and two children (“Taro” and “Hanako”) of the family are exemplified as the plurality of users making the group using the specific vehicle indicated by the vehicle ID.

The item “Key information” is information corresponding to the vehicle key for using the specific vehicle. In this example, “key information” is represented by a combination of a “key number” and a “hash value”. The item “Key number” is information for roughly identifying the key information for each user, and has a configuration with, for example, a common key number followed by a number for each user. However, the present invention is not limited to this. The item “Hash value” is a hash value (illustrated as “xxxxx”) calculated as a unique value from key information (such as a numerical value having a predetermined number of digits) not illustrated. The mobile terminal apparatus 1, a key information server 600 (FIG. 11) described later or the like generates the hash value based on the key information, and assigns the key number to the generated hash value to associate them with each other. When the key information itself is not directly used while such a combination of the “key number” and the “hash value” is used, the user management is made easy, and the security is enhanced.

In the first embodiment, the mobile terminal apparatus 1 of each of users of the group has the key information corresponding to the vehicle key for using the specific vehicle. Each of users can ride on the specific vehicle (for example, unlock the door) by using the vehicle key. Accordingly, the key information of each of users of the group is registered in the key group management information 400. The group in which the key information is registered is described as the key group. In the transmission of the operation instruction from the mobile terminal apparatus 1 to the in-vehicle apparatus 200, note that the key information may be also transmitted from the mobile terminal apparatus 1. The in-vehicle apparatus 200 may also store the similar management information to that of the key group management information 400. The in-vehicle apparatus 200 receives the operation instruction only when receiving correct key information from the mobile terminal apparatus 1. Acquirement of the key information of each of the user terminals will be described later.

The item “Ranking” is ranking information for determining the operation privilege related to the cooperative function and information representing the ranking or the degree of priority among the users of the group as similar to the setting information 11 illustrated in FIG. 1. As the item “ranking”, values in order from, for example, 1 not overlapping one another are set for the plurality of users of the group. In this example, as the rankings of the four users, 1, 2, 3 and 4 are set for the father, the mother, “Taro”, and “Hanako”, respectively as illustrated. For example, when all the four members ride on the specific vehicle, a set of the ranking values for the candidate user terminals is {1, 2, 3, 4}, and the father having the highest ranking value has the operation privilege. When the three members excluding the father ride thereon, a set of the ranking values for the candidate user terminals is {2, 3, 4}, and the mother having the highest ranking value has the operation privilege.

The ranking information may be stored as appended information of the key information in the secure element 116 (FIG. 6). The key group management information 400 may be stored in the secure element 116 (FIG. 6). The ranking information, the operation setting information and the like may be included inside of the key group management information 400, or the ranking information, the operation setting information and the like may be externally set with an associative link. In this example, the key information and the user ID are used as the identification information for identifying the user terminal. However, the present invention is not limited this example.

The item “Operation setting” is also illustrated in the setting information 11a illustrated in FIG. 2, and is information for setting the operation item for enabling the operation instruction by the cooperative function. Each operation item corresponding to the enabled operation depending on the autonomous vehicle 2 (a content of the autonomous driving control or the like) is previously defined. The operation items are also classified by, for example, a level of the autonomous driving. The item “Operation setting” is information for setting in terms of a range or individually indicating which one of all the enabled operation items is allowed for each user. In the item “operation setting” of this example, a value “All” is set for each of the father and the mother while a value “Partial” is set for each of the children (“Taro” and “Hanako”). The value “All” indicates that all of the defined operation instructions are enabled in the mode ON state. The value “Partial” indicates that some of the defined operation instructions are enabled in the mode ON state. Some of operations are previously defined.

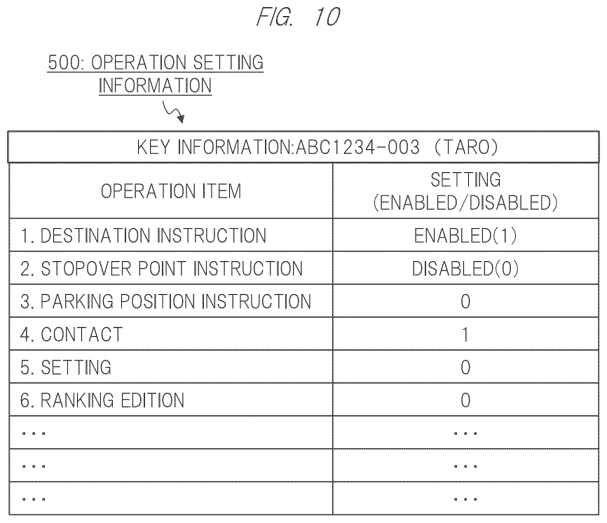

In this example, details of the item “operation setting” are set in operation setting information 500 illustrated in FIG. 10 described later. The item “Operation setting” can be eliminated. In this case, the value “ALL” is set as a default setting. For setting the value “Partial”, details of some operations can be set for each individual user by a user setting.

A second table illustrated in a lower side of FIG. 9 shows another setting example of the key group management information 400. This setting example is a setting example for another specific vehicle, and the users of the group include a user that is an “owner” of the specific vehicle and a user who rides as a guest on the specific vehicle. The user serving as the guest is optionally settable. In this example, a “guest 1” is registered as the guest. A “Guest 2” and subsequent guests have not yet been set but can be added and canceled as needed. In this example, in the setting of the “ranking”, 1 is set for the user serving as the “guest 1”, and 2 is set for the user serving as the “owner”. In a case of this setting example, if single “owner” rides on the specific vehicle at a normal time, the “owner” is in the state with the operation privilege. Further, if single “guest 1” rides on and use the specific vehicle as needed, the “guest 1” is in the state with the operation privilege. If two members that are the “owner” and the “guest 1” ride on and use the specific vehicle, the “guest 1” is in the state with the operation privilege.

The key group management information 400 can be edited by the user as the user setting. If a content of the key group management information 400 at the certain user terminal is edited, the key group management information 400 at each of the user terminals of the group is updated to the same content through synchronous communication. If the ranking information of the key group management information 400 is updated, each of the user terminals determines the operation privilege (step S105 illustrated in FIG. 7) on the basis of the updated ranking information.

A configuration of the key group management information 400 is not limited to the foregoing configuration, but may additionally have attributional information such as sex, age, height, weight, and “a state with/without driver's license possession” as other items. Further, information of a driver's license, a vehicle insurance or the like possessed by the user may be associated with and included in the key group management information 400. In a second embodiment described later, driver information is associated with and included in key group management information 400. The driver information is various types of information (described later) related to a driver of the specific vehicle in a case where the user serving as the driver having the driver's license performs the driving operation or the like.

### [Operation Setting Information]

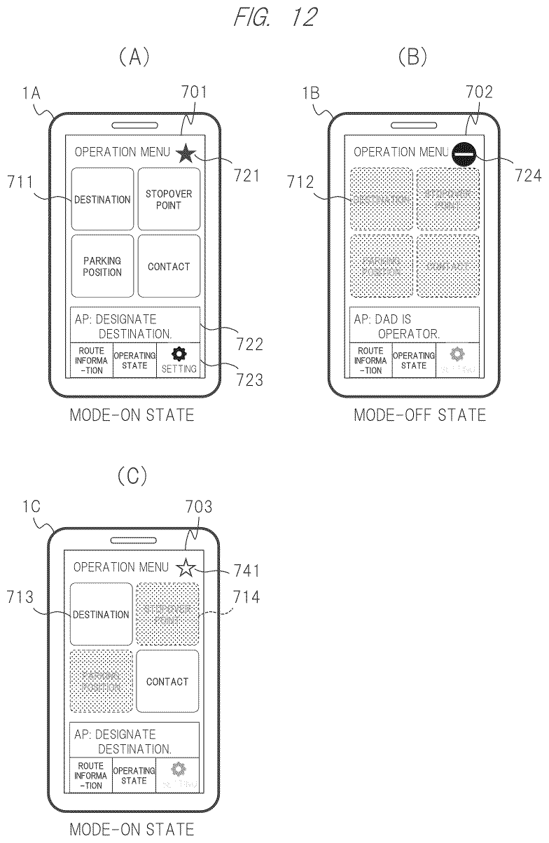

FIG. 10 illustrates a setting example of the operation setting information 500. The operation setting information 500 is settable in association with the key group management information 400. In the key group management information 400 on an upper side of FIG. 9, the value “Partial” of the item “operation setting” is set for the user terminal of the child (“Taro”). The operation setting information 500 illustrated in FIG. 10 represents an example of the operation setting information related to the user terminal of the child (“Taro”). The operation setting information 500 is settable for each key number (a user terminal corresponding thereto). In this example, a table of the operation setting information 500 includes an item “operation item” and an item “setting. In a column for the “operation item”, a plurality of operation items serving as the enabled operation instructions in the cooperative function are prepared as a list. In this example, the column for the “operation item” includes operation items “destination instruction”, “stopover point instruction”, “parking position instruction”, “contact”, “setting”, and “ranking editing”. In the column for the “setting”, a value indicating whether or not the operation is enabled is set for each “operation item”. A value “Enabled (value 1)” indicates that the operation instruction corresponding to the operation item is enabled in the mode ON state, and a value “Disabled (value 0)” indicates that the operation instruction corresponding to the operation item is disabled in the mode ON state. In an example of an operation menu screen described later (FIG. 12), icons corresponding to “destination instruction”, “stopover point instruction”, “parking position instruction” and “contact” are displayed as examples of the operation items. A further detailed setting is applicable for each of the operation items although not illustrated.

### [Acquirement of Key Information]

FIG. 11 illustrates a configuration example of a system in which the mobile terminal apparatus 1 of each of users of the group, such as the terminal 1A of the father (U1) and the terminal 1B of the mother (U2) are connected to an external apparatus such as a server on a communication network 602. Then, FIG. 11 illustrates an example related to an information transmission path or the like in a case of acquirement of the key information of each of user terminals or the like on the system. For example, when each of the user terminals of the group acquires the key information corresponding to the vehicle key of the specific vehicle (vehicle A), the key information can be acquired on this system. Further, the above-described key group management information 400 and operation setting information 500 can also be set on this system.

The key information corresponding to the vehicle key is information that can be actually used to lock and unlock a door of the specific vehicle. On the basis of the key information, the user terminal enables the user to ride on and lock and unlock the specific vehicle and issue the operation instruction to the in-vehicle apparatus 200 of the specific vehicle.

The system illustrated in FIG. 11 includes a key information server 600 and a cooperative server 601 as servers connected onto the communication network 602 such as the Internet. The key information server 600 is a server that securely stores and manages the key information of each user. The cooperative server 601 is a server that performs management, support, and the like related to the cooperative function. Note that the key information server 600 and the cooperative server 601 may be achieved by one computer system. Each of the user terminals (1A and 1B) is appropriately connected to the server (the cooperative server 601 and the key information server 600) via communication of the communication network 602. Each of the user terminals may include an application program or the like for communicating with the server to perform dedicated processing.

A processing example in a case where the mobile terminal apparatus 1 acquires the key information and sets the key information into the key group management information 400 will be described. The key information server 600 previously generates or acquires the key information of each of users. For example, the user (such as the father that is the first user U1) who is the owner of the specific vehicle registers the key information corresponding to the vehicle key of the specific vehicle into the key information server 600 by performing a predetermined registration procedure with the security ensured to the key information server 600. In this example, it is assumed that the key information server 600 generates and stores key information K1 of the terminal 1A of the father (U1) and key information K2 of the terminal 1B of the mother (U2) illustrated in FIG. 1.

The terminal 1A of the father acquires the key information K1 of the terminal itself through communication from the key information server 600. Alternatively, the terminal 1A may read and acquire the key information K1 of the terminal itself from an IC card 603 or the like storing the key information K1. Similarly, the terminal 1B of the mother acquires the key information K2 of the terminal itself through communication from the key information server 600 or the like. In each of the user terminals (1A and 1B), the acquired key information is stored and included in the secure element 116 illustrated in FIG. 6. The mobile terminal apparatus 1 or the key information server 600 may generate the hash value from the key information. For example, the key information server 600 generates the hash value from the key information K1. The terminal 1A of the father acquires the hash value from the key information server 600, associates a key number and the hash value with each other, and stores them in the item “key information” of the key group management information 400 illustrated in FIG. 9.

As a modification example, the key information corresponding to the vehicle key of the specific vehicle may be key information (also described as shared key information) shared among the users of the group. For example, the terminal 1A of the father (the first user U1) who is the owner of the vehicle A as a specific vehicle registers and acquires the key information of the vehicle A. On the other hand, the other user terminal such as the terminal 1B of the mother (U2) of the group acquires the key information of the vehicle A as the shared key information from the terminal 1A of the father (U1) or the key information server 600. For example, the terminal 1B of the mother (U2) is connected to the terminal 1A of the father (U1) through one-to-one link communication to acquire the shared key information.

The key group management information 400 illustrated in FIG. 9 is set on the basis of the acquirement of the key information. For example, the terminal 1A of the father sets and stores the key group management information 400A into the terminal itself. Alternatively, the terminal 1A may set the key group management information 400A into the cooperative server 601. The key group management information 400A of the terminal 1A of the father includes key information K1, ranking information R1, operation setting information M1, and the like. A content of the key group management information 400A set by the father needs to also be reflected on the other user terminal of the group through synchronization. For example, the terminal 1A of the father is connected to the terminal 1B of the mother through one-to-one link communication, and transmits the content of the key group management information 400A. The terminal 1B of the mother receives the content, and updates a content of the key group management information 400B of the terminal itself. The key group management information 400B of the terminal 1B of the mother includes at least key information K2, ranking information R2, operation setting information M2, and the like.

Alternatively, the terminal 1A of the father may notify the terminal 1B of the mother of the setting updating, and the terminal 1B of the mother may access the cooperative server 600 and acquire the latest key group management information 400 (including the content of the key group management information 400A of the father) registered in the cooperative server 601.

As another setting method, for example, the father (U1) may set a content (such as operation setting information 500) of key group management information of the other user (such as child). The privilege related to a setting may be prepared among the users of the group. For example, the father and the mother have a privilege to be able to set the setting information of the child.

In the user terminal or the server, note that the key group management information 400 may be set as appended information of the key information, and a pair of the key information and the key group management information 400 may be stored. Between the user terminals or between the user terminal and the server, the pair of the key information and the key group management information 400 may be transmitted simultaneously or separately at different timings.

In a modification example described later, when the key group management information 400 is registered into the cooperative server 601, a remotely-existing user terminal can acquire and refer to the key group management information 400 from the cooperative server 601 and can register the key group management information 400 into the cooperative server 601. Each of the user terminals of the group may download and acquire the key group management information 400 from the cooperative server 601 at predetermined timing such as the time of activation of an application software.

### [Screen Example: Operation Instruction]

FIG. 12 illustrates a screen example in the mobile terminal apparatus 1. FIG. 12A illustrates an example of an operation menu screen in the mode ON state in the display of the touch panel of the terminal 1A of the first user U1 (father). FIG. 12B illustrates an example of an operation menu screen in the mode OFF state in the terminal 1B of the second user U2 (mother). FIG. 12C illustrates an example of an operation menu screen in the mode ON state in the terminal 1C of the third user U3 (child “Taro”). The value “Partial” of the operation setting information is set for the terminal 1C of the child. The operation menu screen on which the state with/without the operation privilege (the mode ON/OFF) and the content of the operation setting information 500 are reflected is displayed on the display screen of each of user terminals.

In FIG. 12A, a GUI including a plurality of operation item buttons 711 (such as icons) in the state with the operation privilege (the mode ON state) such that all operation instructions are enabled is displayed on an operation menu screen 701 of the terminal 1A of the father. In this example, the operation items include four operation items “destination”, “stopover point”, “parking position”, and “contact”. Each of the buttons 711 is displayed with a workable normal state. The father (U1) can issue the operation instruction by pressing the selected button 711 by a touch. On the operation menu screen 701, a mark 721 indicating the state with the operation privilege (the mode ON state) is also displayed (although not essential). Further, in a lower portion of the operation menu screen 701, for example, a guidance message 722 based on an application software to the user and other items 723 such as “route information”, “operating condition”, and “setting” are displayed. For example, the item “route information” is an item of a function for displaying and confirming route information to the destination.

In FIG. 12B, a GUI including a plurality of operation item buttons 712 in the state without the operation privilege (the mode OFF state) such that all operation instructions are disabled is displayed on an operation menu screen 702 of the terminal 1B of the mother. On the operation menu screen 702, a mark 724 indicating the state without the operation privilege (the mode OFF state) is also displayed (although not essential). Each of the buttons 712 is displayed with a gray color and is closed as an unworkable state, and therefore, cannot be pressed. Note that an item such as the “route information” that may be operated without any problem by each of the users is displayed with a workable state. When, for example, the mother (U2) desires to have the operation privilege in place of the father (U1), note that the operation privilege can be changed by another mechanism (such as a temporary ranking change and an operation permission) described later, and a GUI for this is prepared on the screen.

In FIG. 12C, a GUI including buttons 713 and 714 is displayed on an operation menu screen 703 of the terminal 1C of the child (“Taro”) such that some of operation instructions are enabled on the basis of the operation setting information 500 when the terminal 1C of the child has the operation privilege (the mode ON state). In this example, among the four operation instruction buttons 711 illustrated in FIG. 12A, the two buttons 713 for the “destination” and the “contact” are displayed with the workable state, and the two buttons 714 for the “stopover point” and the “parking position” are displayed with the gray color as the unworkable state. The child (“Taro”) can issue the operation instruction by pressing the buttons 713 for the “destination” and the “contact”.

The mobile terminal apparatus 1 generates the operation instruction 13 (operation instruction information corresponding thereto) by the input operation such as the touch operation to the operation item button on the above-described operation menu screen. In the mobile terminal apparatus 1, when trying to generate the operation instruction for, for example, the item “destination”, the user designates a destination on the screen, and the mobile terminal apparatus 1 generates a command corresponding to an autonomous operation instruction having the designated destination as the destination and transmits the command to the in-vehicle apparatus 200. When there are a large number of operation items, note that the operation menu screen may be made of a plurality of screens with a hierarchical structure, pages, or the like, or its display may be controlled by scrolling or the like. Further, the operation instruction can also be achieved by an audio input and an audio recognition.

### [Screen Example: User List]

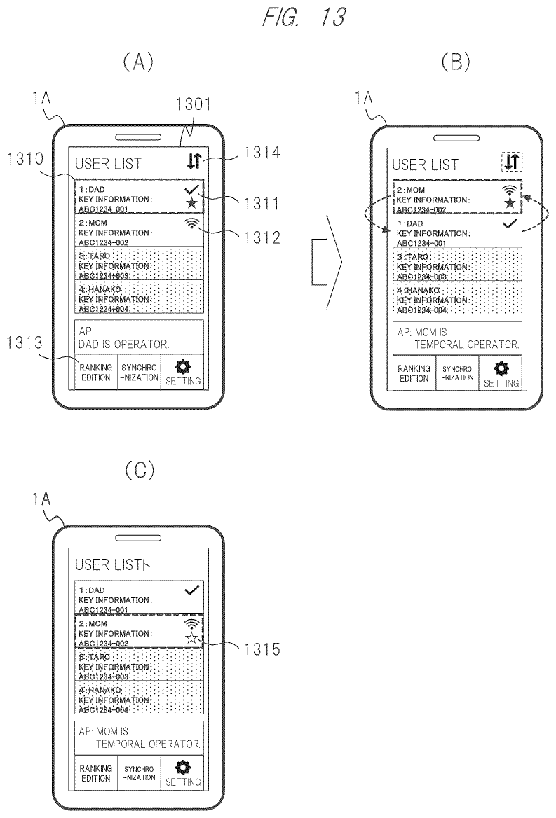

FIG. 13 illustrates a screen example of a user list as another screen example in the mobile terminal apparatus 1. FIG. 13A illustrates a display example of a screen 1301 of the user list of the terminal 1A of the father (U1). Various types of screens can be selected and displayed depending on the input operation in the mobile terminal apparatus 1 performed by the user. The user list is a list of information about each user of the group based on the key group management information 400. The screen 1301 of this user list is a screen for confirming the information about the users of the group and editing the ranking or the like. Particularly, in this user list, each of the user information is displayed in a state in which the plurality of users of the group are arrayed, for example, vertically in accordance with the ranking set by the above-described ranking information. In this example, the father, the mother, the child 1 and the child 2 are displayed as the user information in this order in accordance with the “ranking” of the key group management information 400 illustrated in FIG. 9. A user information item 1310 includes information such as the ranking, the display name, and the key number.

Further, in the user list, information about a group terminal that has been detected as the terminal itself is normally displayed, and information about a group terminal that has not been detected as it is displayed with, for example, the gray color. In this example, respective items of the father and the mother are normally displayed, and respective items of the child 1 and the child 2 are displayed with the gray color. A check icon 1311 indicates a user of the terminal itself. An electric-wave icon 1312 indicates a “currently-in-progress” state of communication (such as a currently-in-progress state of connection through one-to-one link communication) with the terminal itself. Further, a user information item corresponding to a user having the operation privilege at the current time point is emphasized and displayed with, for example, a dashed frame. Not only the present invention is not limited to this. A mark (an asterisk mark in this example) indicating the state with the operation privilege may be displayed in the corresponding user information item.

The icon “ranking editing” 1313 is used in edition of the ranking information of the key group management information 400 to formally update the setting. The icon “synchronization” is used in execution of synchronization of the setting information. The icon “setting” is used in other setting. In setting for the ranking information by using the icon “ranking editing” 1313 or setting for another information by using the icon “setting”, the setting may be received by displaying, for example, respective contents of the key group management information 400 as illustrated in FIG. 9 and the operation setting information 500 as illustrated in FIG. 10 on the screen. An example of the updating of the setting for the ranking information is also illustrated in FIG. 2. An up-down arrow icon 1314 is used in edition of temporary ranking replacement (temporary ranking setting). This temporary ranking setting is a function of being able to not formally update the setting but temporarily replace the rankings.

FIG. 13B illustrates an example of the temporary ranking setting. The father (U1) in the state with the operation privilege operates the up-down arrow icon 1314 to select the desired user information item of the user list, and move the user information item to a desired up or down position. In this example, the item of the mother is moved to an uppermost position of the item of the father by the touch operation, and accordingly, the item of the father is moved to the original position of the item of the mother. That is, the respective items of the father and the mother are replaced with each other. The ranking of the father and the ranking of the mother remain 1 and 2, respectively, and the formal ranking information is maintained. The array of the user information items of this user list is handled as the temporary ranking. That is, the temporary ranking of the mother is 1 because the item of the mother is arranged in the uppermost position, and the temporary ranking of the father is 2 because the item of the father is arranged on the second position from the top. Note that the present invention is not limited to this. The “temporary ranking” may be displayed on the screen separately from the formal ranking.

For setting the temporary ranking, the formal ranking information of the key group management information 400 stored in the storage or the like is not updated but stored, and the temporary ranking information is generated on the memory. In each of the user terminals, when the temporary ranking is applied (the application state in this example is the pressed state of the up-down arrow icon 1314), the operation privilege is determined by using not the formal ranking information but the temporary ranking information. In this example, among the candidate user terminals (the father and the mother), the mother (U2) having the highest temporary ranking 1 is in the state with the operation privilege. For the temporary ranking setting, synchronous communication is performed between the user terminals of the group. On the screen of each of the user terminals, information indicating that the mother temporarily has the operation privilege is displayed. As a result, the mode of the terminal 1B of the mother (U1) is turned to the mode ON state.

For canceling the temporary ranking setting, for example, the father (U1) presses and bring the up-down arrow icon 1314 again to an inapplicable state. As a result, the temporary ranking of the user list is canceled, the temporary ranking information is deleted, and the screen is returned to the original screen state as illustrated in FIG. 13A. Alternatively, the temporary ranking may be canceled, for example, after an elapse of a predetermined time period from the start of the setting, at end of the application software, detection of the exiting or the like.

FIG. 13C illustrates another example of control related to the temporary ranking setting. In this example, the “temporary operation privilege” is settable in a state in which the array of the user information items of the user list remains unchanged as similar to that illustrated in FIG. 13A. For example, the father (U1) selectively operates the user information item of the mother (U2), and gives the temporary operation privilege. On a screen in the user information item of the mother, a mark 1315 or the like indicating the state with the temporary operation privilege is displayed. The temporary operation privilege may be internally set to correspond to the temporary ranking information, or a setting of the temporary ranking information may be omitted. For canceling the temporary operation privilege, for example, the father (U1) selectively operates the user information item of the mother to cancel the temporary operation privilege. As a result, the screen is returned to the original screen state as illustrated in FIG. 13A.

A function of setting the temporary ranking or the temporary operation privilege as described above provides convenience with less setting time and effort, a temporarily-replaceable operation instructor, a temporarily-transferable operation privilege and the like.

### [Screen Example: KEY List]

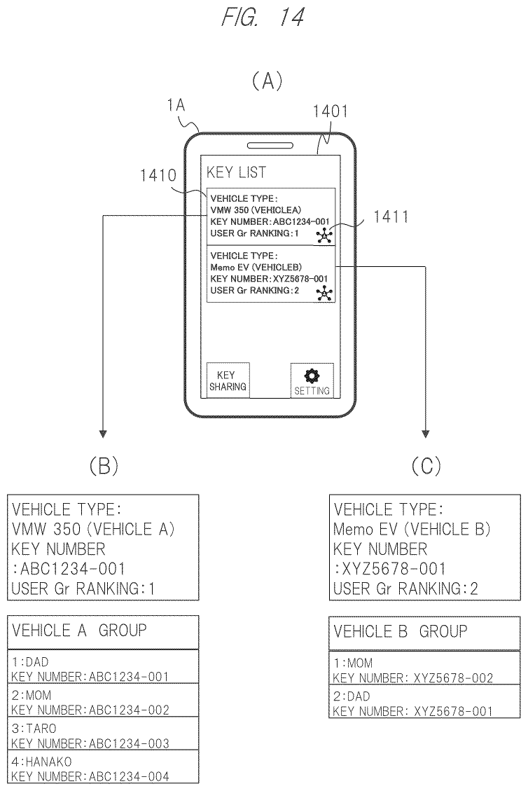

FIG. 14 illustrates a screen of a key list as another screen example in the mobile terminal apparatus 1. FIG. 14A illustrates a screen 1401 of the key list in the terminal 1A of the father (U1). This key list is a list of the vehicle keys of the usable vehicles for a certain user (such as father). In this key list in this example, key information KA of a vehicle A and key information KB of a vehicle B are included in the key information which the first user U1 (father) has, and are displayed as a key information item 1410. In this example, the key information item 1410 includes a vehicle type, a vehicle ID, a key number, and a ranking of the user (father) of the group. A group icon 1411 indicates that there is a user of the group who has the key information of the vehicle in the key information item. Information about the group can be confirmed in accordance with an operation on the group icon 1411.

FIG. 14B illustrates an enlargement of the key information item of the vehicle A and a setting example of a group related to the vehicle A, and FIG. 14C illustrates an enlargement of the key information item of the vehicle B and a setting example of a group related to the vehicle B. Thus, a group can also be set for each of the vehicles. In the group for each of the vehicles, a different member user and a different ranking can also be set. In this example, in the ranking information of the vehicle A, 1 and 2 are set for the father and the mother, respectively. In the ranking information of the vehicle B, 1 and 2 are set for the mother and the father, respectively. That is, the priority in the usage of the vehicle A is put on the father, and the priority in the usage of the vehicle B is put on the mother.

### [State Output]

FIG. 15 illustrates an example of output of the state of the operation privilege from each of user terminals in a similar vehicle to that illustrated in FIG. 1. In the example illustrated in FIG. 15, each of the users (U1, U2) carries and wears a wearable terminal in addition to each of the mobile terminal apparatuses 1 (1A and 1B) that is the smartphone. The first user U1 (father) has a wearable terminal 3A, and the second user U2 (mother) has a wearable terminal 3B. Each of the wearable terminals cooperates with the mobile terminal apparatus 1 through communication.

As illustrated in, for example, FIG. 4 described above, the mode of the terminal 1A of the father (U1) is turned to the mode ON state while the mode of the terminal 1B of the mother (U2) is turned to the mode OFF state on the basis of the determination of the operation privilege in step S3. At this time, the wearable terminal 3A that has cooperated with the terminal 1A of the father (U1) performs a predetermined output 1501 (display and audio output) indicating that the mode has been turned to the mode ON state with the operation privilege. An example of the audio output is a predetermined musical scale (such as “Do Mi So in Japanese (C E G in English) [symbol] ”). Further, the wearable terminal 3B that has cooperated with the terminal 1B of the father (U2) performs a predetermined output 1502 (display and audio output) indicating that the mode has been turned to the mode OFF state without the operation privilege. An example of the audio output is a predetermined musical scale (such as “So Mi Do in Japanese (G E C in English) [symbol] ”). As a result, each user can understandably recognize the respective mode states of the terminal itself and the other terminal.

### Effect of First Embodiment and Others

As described above, according to the mobile terminal apparatus 1 enabling the operation instruction to the autonomous vehicle 2 in the first embodiment, when the autonomous vehicle 2 is used by the plurality of members of the family or the like, the operation to the autonomous vehicle 2 can be more preferably achieved. According to the first embodiment, when the plurality of candidate users exist near the autonomous vehicle 2, for example, when the plurality of candidate users are immediately before the riding thereon, it can be automatically and easily determined, for example, which one of the candidate users the operation privilege is given to first. Accordingly, the operation instruction can be smoothly issued to the autonomous vehicle 2 after the riding to start the autonomous operation or the like. According to the first embodiment, for example, the need for each of occupants to check the display information and determine who should have the operation privilege, the time and effort for the operation for giving the operation privilege, and the like can be made smaller than those of the related-art technique as described in the Patent Document 1. In the technique as described in the Patent Document 1, the qualification of each of occupants is only displayed, and each of the occupants needs to determine who is made to have the operation privilege. On the other hand, according to the first embodiment, it can be automatically and easily determined who should have the operation privilege. The cooperative function in the first embodiment is also applicable to a case where the operation instruction is transmitted to the partially autonomous vehicle.

According to the first embodiment, even when the user of the group who rides on the specific vehicle changes, the operation privilege can be automatically determined on the basis of the ranking information, and the management of the operation privilege can be achieved with less time and effort.

Further, the first embodiment is also applicable when the specific vehicle on which the user of the group rides changes, and is also applicable when the family has the plurality of vehicles and when car sharing is used. In such a case, there is no need to input and set the information such as the attribution of the user every time of the change of the vehicle used by the user, and the management of the operation privilege of each of vehicles can be achieved with less time and effort. Even when the vehicle on which the user rides changes, the operation privilege can be automatically determined on the basis of the ranking information.

Therefore, according to the first embodiment, improvement of movement convenience using the autonomous vehicle can be expected, and the first embodiment contributes to achievement of the eleventh goal “Sustainable Cities and Communities” of the Sustainable Development Goals (SDGs) advocated by the United Nations.

In the first embodiment, note that the case of the operation instruction performed inside the vehicle (FIG. 4) by the user having the operation privilege determined around the specific vehicle (FIG. 3) has been described. However, the present invention is not limited to this. The user who issues the operation instruction to the specific vehicle may not be the occupant but be outside the vehicle. For example, in order to move the vehicle to a parking lot or the like, the user having the operation privilege who is outside the vehicle can issue the operation instruction to the vehicle through the terminal. Further, as a modification example of the first embodiment, various modification examples described below are applicable.

### First Modification Example: Guest

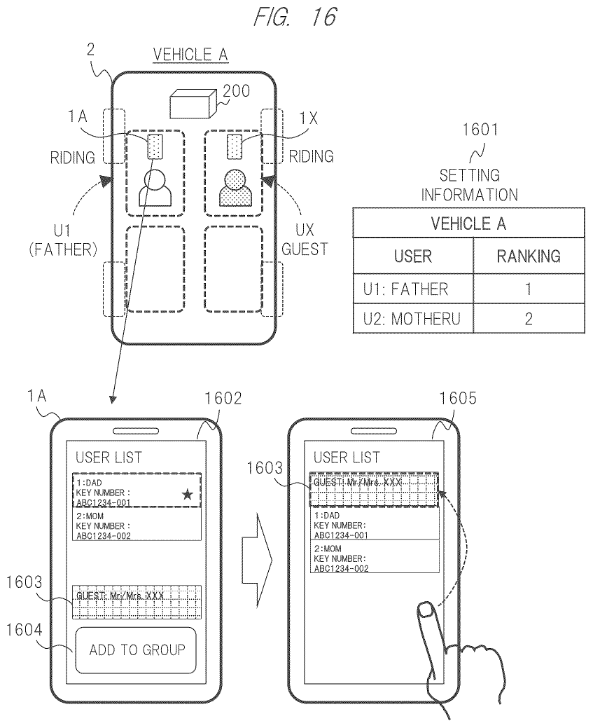

FIG. 16 is an explanatory diagram of a function of adding the guest to the group or the like in a certain modification example (referred to as first modification example). This first modification example includes a function of adding a new member as a guest other than the previously set group user and a function of setting the ranking or the temporary ranking to the guest. In setting information 1601 of FIG. 16, for example, first, the father (U1) and the mother (U2) are set as a group using the vehicle A, and 1 and 2 are set for the rankings thereof.

First, it is assumed that only the father (U1) is riding on the vehicle A. At this time, the father (U1) has the operation privilege on the basis of the ranking information. Then, it is assumed that the guest (referred to as a user UX) rides on the vehicle A in the middle of the operation. The user UX is the user outside the group, and does not have the ranking information or the like. The terminal 1A of the father (U1) detects a terminal 1X of the guest (UX) through the inter-terminal communication.

In the terminal 1A of the father (U1), information indicating that the terminal 1X of the guest (UX) has been detected and an item 1603 of user information of the guest (UX) are displayed on a screen (such as user list screen 1602) to encourage the father to confirm and determine whether or not the terminal 1X of the guest (UX) is added to the group. For example, on the screen, the father (U1) performs an operation for adding the guest (UX) to the group. This operation is, for example, an operation on a button 1604 or an operation for arranging the item 1603 of the guest (UX) to a desired position of the user list. A screen 1605 shows a case where the item 1603 of the guest (UX) is arranged at an uppermost position of the group. The terminal 1A adds the guest (UX) to the group in accordance with the operation. This addition may be temporary performed, or can also be canceled later.

Further, the terminal 1A of the father (U1) sets a ranking for the guest (UX) added to the group. In this example, the setting of the ranking for this guest (UX) is the above-described temporary ranking setting. In this example, the father (U1) arranges the item 1603 of the guest (UX) at an uppermost position of the user list by an operation as shown in the screen 1605. As a result, the terminal 1A sets a temporary ranking of the guest (UX) to 1 and sets respective temporary rankings of the father and the mother to 2 and 3. As a result, the terminal 1X of the guest (UX) is made in the state with the operation privilege (in other words, a temporary operation privilege) by the determination of the operation privilege on the basis of the temporary ranking. In the terminal 1X of the guest (UX) to which the operation privilege is given, the operation menu screen is displayed on the screen, and therefore, the guest (UX) can transmit the operation instruction to the in-vehicle apparatus 200. The guest (UX) can be formally set, if needed, by the ranking editing and the setting items as similar to FIG. 13 described above.

Then, if it is desired to cancel the ranking and the operation privilege of the guest (UX), the father (U1) can perform, for example, an operation for selecting the item 1603 of the guest (UX) to rearrange its position, an operation for issuing a cancel instruction of the ranking and the operation privilege, an operation for deleting the guest (UX) from the group and the like, on the screen of the terminal 1A.

According to the first modification example, the guest can be easily added to the group, and the operation can be easily temporary replaced.

### Second Modification Example: Remote Terminal

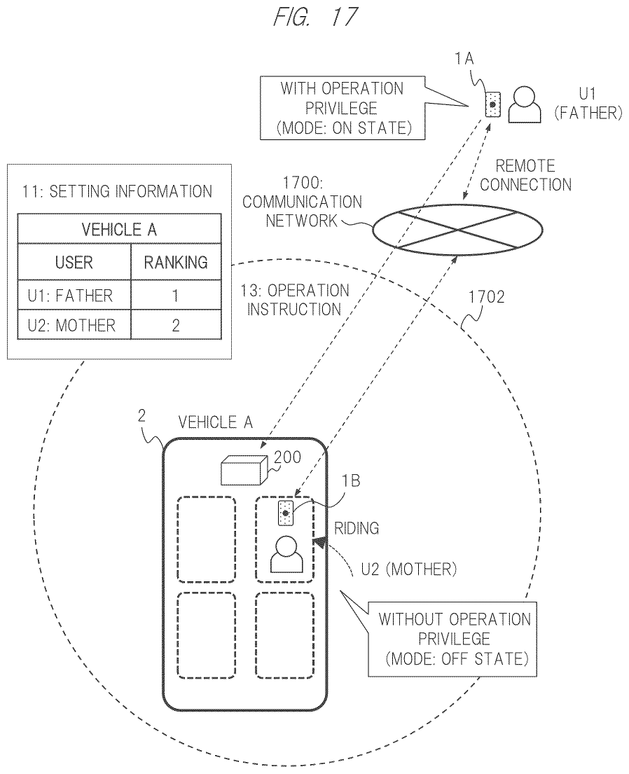

As a second modification example, FIG. 17 illustrates an explanatory diagram related to a function of being able to also give the operation privilege to the remote user terminal. The above-described first embodiment shows the case where the operation privilege is determined for the occupant actually existing near the specific vehicle on the basis of the ranking information and the inter-terminal communication 12 via the predetermined near field communication interface (for example, FIG. 3). The present invention is not limited to this. In the second modification example, the operation privilege is also controlled for a person who does not ride on the specific vehicle, such as a user terminal at a remote site (outside a predetermined distance range) from the specific vehicle, regarded as the candidate user terminal.

In an example illustrated in FIG. 17, a user (assumed to be the first user U1 who is the father) of the group is at a remote site from a vehicle A that is the specific vehicle via a communication network 1700 or the like. The second user U2 (mother) of the group is near the vehicle A. The example shows a case where the mother (U2) rides on the vehicle A. In the setting information 11 of the group, it is assumed that the rankings of the father (U1) and the mother (U2) are 1 and 2, respectively. A range 1702 is a communication range via a predetermined near field radio communication interface centered around the terminal 1B of the mother.

The terminal 1B of the mother (U2) uses a predetermined long-distance communication interface different from the above-described near field radio communication interface, and determines and detects whether or not the other user terminal of the group is remotely connected within a predetermined remote range from a position of the terminal itself (or the specific vehicle). In this example, it is assumed that the terminal 1A of the father (U1) is remotely connected to the terminal of the mother (U2). Note that the remote connection may be detected as follows. The remote user terminal (the terminal 1A of the father) may notify the user terminal (the terminal 1B of the mother) near the specific vehicle that it has been remotely connected thereto. Alternatively, the remote user terminal may be connected to the cooperative server 601 (FIG. 11) on the communication network 1700, and the cooperative server 601 may notify the user terminal near the specific vehicle that the remote user terminal has been remotely connected thereto. Alternatively, the remote user terminal may be connected to the in-vehicle apparatus 200 of the specific vehicle, and the in-vehicle apparatus 200 may notify the user terminal near the specific vehicle that the remote user terminal has been remotely connected thereto. The user terminal near the specific vehicle may access the cooperative server 601 or the in-vehicle apparatus 200 to confirm the presence or absence of the remote connection.

The terminal 1B of the mother also regards the remotely-connected terminal 1A of the father as the candidate user terminal, and confirm its ranking information. In this example, the terminal 1B itself of the mother does not have the operation privilege and is in the mode OFF state because the terminal itself has a lower ranking than that of the remotely-connected terminal 1A of the father. The terminal 1A itself of the father has the operation privilege and is in the mode ON state because the terminal itself has a higher ranking. The mode-ON terminal 1A of the father (U1) displays the operation menu screen as similar to the above description, and the father (U1) can perform the operation for inputting the operation instruction on the screen. Accordingly, the remote terminal 1A transmits the operation instruction 13 to the in-vehicle apparatus 200 via the communication network 1700.

In such a remotely-connected terminal, note that an operation menu screen including an operation item for a remote operation instruction may be prepared. In this case, by application of operation setting information for the remote operation instruction, the operation instructions may be limited such that only some of them are enabled.

### Third Modification Example: Vehicle Position

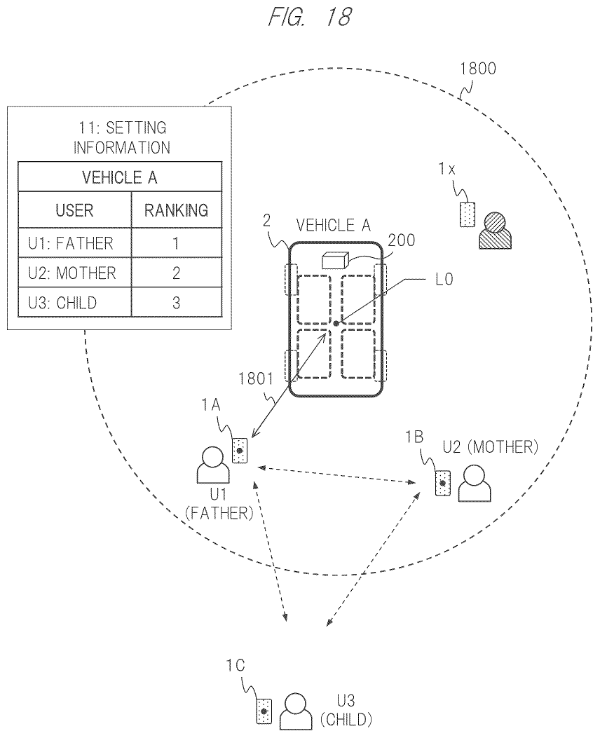

As a third modification example, FIG. 18 illustrates an explanatory diagram in a case where the operation privilege is also controlled by using vehicle position information of the specific vehicle in consideration of a positional relationship between the specific vehicle and the user terminal. In a basic control example of the above-described first embodiment, the operation privilege is determined only by the surrounding state or the positional relationship among the user terminals of the group. In the third modification example, the operation privilege is also further determined in consideration of the positional relationship between the position of the user terminal and the position of the specific vehicle. Each user terminal recognizes a position of the terminal itself and a position of the specific vehicle by using a technique such as a GPS.

In FIG. 18, the vehicle A that is the specific vehicle used by the group is arranged at a vehicle position represented by vehicle position information L0 (such as a latitude and a longitude based on the GPS). A range 1800 is a range based on a predetermined radial distance centered around the vehicle position information L0. In the third modification example, the above-described operation privilege is controlled in accordance with the presence or absence of each user terminal of the group within the range 1800 of the vehicle position. In this example, the terminal 1A of the father (U1) and the terminal 1B of the mother (U2) are present within the range 1800, and the terminal 1C of the child is out of the range 1800. Each of the user terminals acquires the position information of the terminal itself and the vehicle position information L0 of the vehicle A. Each of the user terminals determines whether or not the terminal itself is present within the predetermined range 1800 from the vehicle position. Each of the user terminals determines a distance between the position information of the terminal itself and the vehicle position information L0 of the vehicle A, and determines whether or not the distance is within a distance corresponding to the range 1800. For example, a distance 1801 between the terminal 1A of the father (U1) and the vehicle A is smaller than the radial distance of the range 1800.

When being within the range 1800, the user terminal performs, for example, the processes in step S2 and subsequent steps illustrated in FIG. 3 described above while regarding the terminal itself as the candidate user terminal. When being out of the range 1800, the user terminal does not perform the processes in step S2 and subsequent steps described above. That is, the operation privilege is not given to the user terminal being out of the range 1800. Further, even when a general user terminal unrelated to the group for the specific vehicle or a user terminal (such as terminal 1x) of the other group is present within the range 1800, this user terminal is not regarded as the candidate user terminal. In this example, the father (U1) and the mother (U2) are present within the range 1800. Accordingly, on the basis of the ranking information, it is determined that the terminal 1A of the father (U1) should have the operation privilege. The range 1800 or the like is user-settable.

According to the third modification example, the operation privilege can be automatically determined in accordance with the setting of the range 1800 in the limit case such as the riding near the specific vehicle.

### Fourth Modification Example: Riding Situation

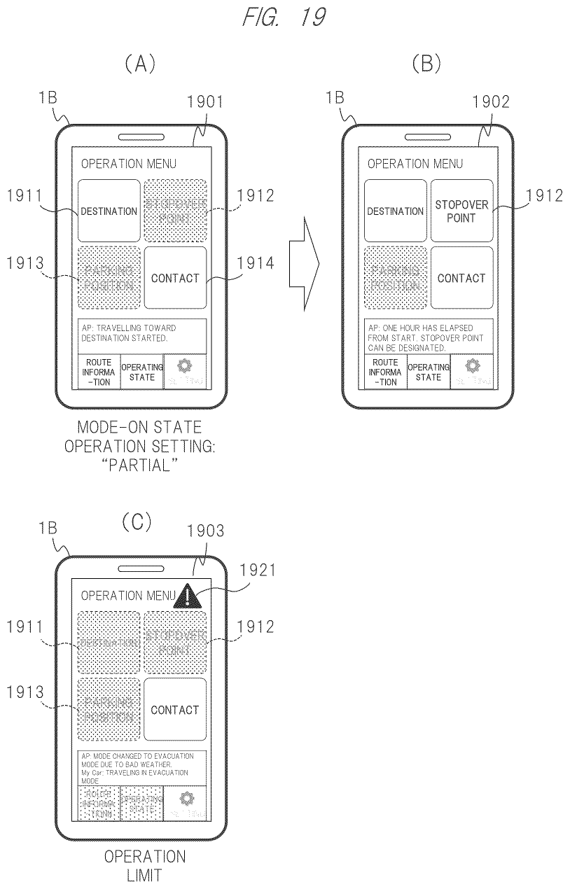

As a fourth modification example, FIG. 19 illustrates an example of the operation menu screen of the mobile terminal apparatus 1. The mobile terminal apparatus 1 in the fourth modification example automatically changes the content of the operation menu screen in accordance with a situation of the riding on the specific vehicle. Particularly, the mobile terminal apparatus 1 changes the operation item enabled for the operation instruction on the screen in accordance with the riding situation. In the fourth modification example, control of the operation item corresponding to the riding situation is added on the premise of the functions as described in the first embodiment. As the riding situation, a time period elapsed from the user's riding on the specific vehicle, a traffic jam situation of a road traffic network, and situations such as weather and a natural disaster are exemplified.

The mobile terminal apparatus 1 may receive and acquire information related to the riding situation from the in-vehicle apparatus 200 or may receive and acquire the information from an external server or the like, or the terminal itself may acquire the information by using the sensor or the like. For example, in accordance with the riding situation, from the in-vehicle apparatus 200, the mobile terminal apparatus 1 receives and acquires information indicating whether or not the autonomous driving can be continued or should be intermitted. Alternatively, for example, the mobile terminal apparatus 1 acquires emergency warning information indicating occurrence of an earthquake, a tsunami or the like.

FIG. 19 shows the following modification example of the operation menu screen corresponding to the riding situation. FIG. 19A illustrates an operation menu screen in the terminal 1B of the mother (U2) at the start of riding on the vehicle A. It is assumed that the terminal 1B of the mother (U2) is in the mode ON state. In this example, the value “Partial” in the operation setting is set for the mother (U2). The details of the setting “Partial” include the item “destination” and the item “contact”, and the operation items disabled for the operation instructions include the item “stopover point” and the item “parking position”. On an operation menu screen 1901 illustrated in FIG. 19A, the operation item “destination” 1911 and the operation item “contact” 1914 are displayed with the state where the operation instruction is enabled, and the operation item “stopover point” 1912 and the operation item “parking position” 1913 are displayed with the gray color as the state where the operation instruction is disabled.

FIG. 19B illustrates an operation menu screen 1902 of the terminal 1B of the mother (U2) prepared at the time of change of the riding situation. It is assumed that a certain period of time has elapsed from the start of riding. The mobile terminal apparatus 1 measures a time period elapsed from the start of user's riding, and changes the operation item when the elapsed time period exceeds a set time period. For example, the state of the operation item “stopover point” 1912 is changed to the state where the operation instruction is enabled. As a result, in accordance with the operation instruction of the item “stopover point”, the user can issue an instruction to, for example, stop by a restroom.

FIG. 19C illustrates an operation menu screen 1903 of the terminal 1B of the mother (U2) prepared at the time of change of the riding situation. As the riding situation, a case where the emergency warning information due to the bad weather or occurrence of the disaster has been received is exemplified. In this case, the terminal 1B cooperates with the in-vehicle apparatus 200, and the in-vehicle apparatus 200 automatically operates in an evacuation mode when the autonomous driving cannot be continued. From the in-vehicle apparatus 200, the terminal 1B receives information indicating that the driving should be in the evacuation mode. The evacuation mode is an autonomous driving mode corresponding to, for example, the earthquake, the tsunami or the like. The screen of the terminal 1B displays an alert icon 1921 indicating that the operation instructions are limited on the basis of the emergency warning or the like. The screen of the terminal 1B displays information indicating that the mode has shifted to the evacuation mode on the basis of the emergency warning or the like. Then, in the terminal 1B, the content of the operation menu screen is changed to limit the operations to the operation corresponding to the evacuation mode. In this example, the states of the operation item “destination” 1911 and the operation item “stopover point” 1912 are changed to the state where the operation instruction is disabled. Then, when the autonomous driving is allowed again in accordance with the change of the riding situation, the terminal 1B returns the state of the predetermined operation item on the operation menu screen into the workable state.

### Fifth Modification Example: Subordination Relationship

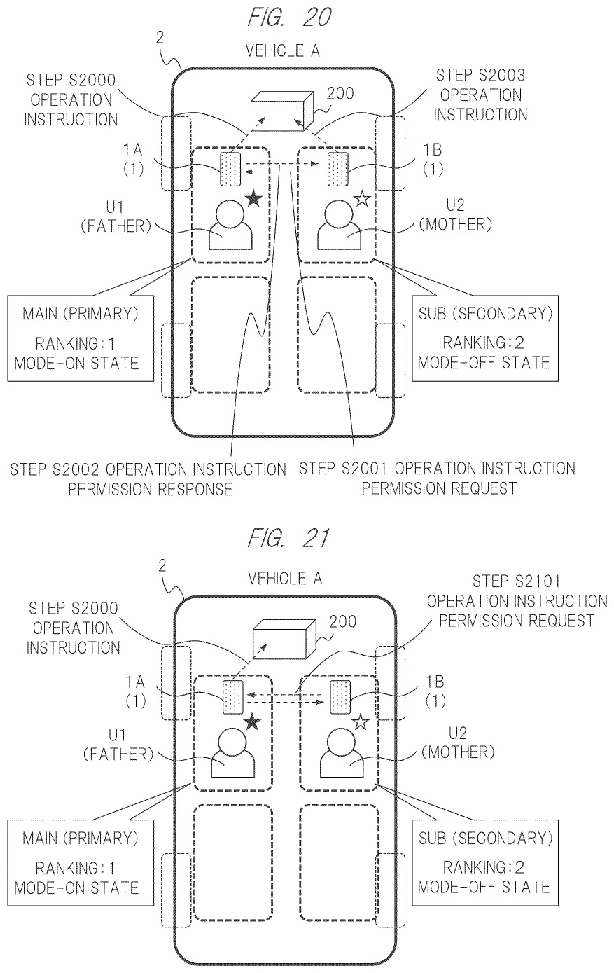

As a fifth modification example, FIG. 20 illustrates an explanatory diagram in a case where a concept of a subordination relationship between, for example, a primary and a secondary is added between the user terminals of the group. For example, in a certain group, the terminal 1A of the first user U1 (father) is the primary (referred to as primary user terminal) as the attribution for control, and the terminal 1B of the second user U2 (mother) is the secondary (referred to as secondary user terminal) as the attribution for control. The setting of the primary and the secondary is performed in, for example, the key group management information 400 (FIG. 9).

The primary user terminal can issue the operation instruction to the in-vehicle apparatus 200 when being turned to the mode ON state with the operation privilege on the basis of the ranking information as similar to the first embodiment. The secondary user terminal can issue the operation instruction to the in-vehicle apparatus 200 when receiving, from the primary user terminal, information indicating that the predetermined operation instruction allowed by the operation setting information 500 (FIG. 10) is enabled. The operation instruction from the secondary user terminal may be enabled in a case where the mode is turned to the mode ON state with the operation privilege, or may be enabled regardless of either the mode ON state or the mode OFF state. Explanation in this example is made in a case where the mode of the primary user terminal is turned to the mode ON state while the mode of the secondary user terminal is turned to the mode OFF state on the basis of the ranking information of the group such that the mode-OFF secondary user terminal can issue the operation instruction on the basis of the permission from the primary user terminal.

In an example illustrated in FIG. 20, the terminal 1A of the father that is the primary user terminal and the terminal 1B of the mother that is the secondary user terminal are riding on the vehicle A, and the terminal 1A and the terminal 1B are in the mode ON state and the mode OFF state, respectively, on the basis of the ranking information. In step S2000, the terminal 1A that is the primary user terminal is in the mode ON state, and can transmit the operation instruction to the in-vehicle apparatus 200 on the basis of the input operation performed by the father (U1). On the other hand, in step S2001, the terminal 1B that is the secondary user terminal is in the mode OFF state, and transmits an operation instruction permission request for acquiring a permission related to the operation instruction to the terminal 1A that is the primary user terminal on the basis of the input operation performed by the mother (U2). For example, the mother (U2) selectively operates the enabled operation item on the screen, and the terminal 1B transmits the operation instruction permission request with information about this operation item. The primary user terminal receives the request and displays the request on the screen, and the father (U1) confirms the request and presses a permission button if permitting the request. In step S2002, the terminal 1A transmits an operation instruction permission response to the terminal 1B that is the secondary user terminal. In step S2003, the terminal 1B has acquired the permission because of the response, and therefore, transmits the operation instruction for the selected operation item to the in-vehicle apparatus 200. If the father (U1) has not permitted the request, note that a non-permission response is transmitted to the terminal 1B of the mother (U2).

FIG. 21 illustrates a modification example in which some of steps differ from those illustrated in FIG. 20. In step S2101, the terminal 1B that is the secondary user terminal transmits the operation instruction permission request to the terminal 1A that is the primary user terminal, on the basis of the operation for selecting the operation item on the screen performed by the mother (U2). The terminal 1A receives the request and displays the request on the screen, and the father (U1) confirms the request and presses the permission button if permitting the request. In step S2102 after the permission, the terminal 1A that is the primary user terminal transmits the operation instruction to the in-vehicle apparatus 200 in place of the secondary user terminal. Further, the terminal 1A transmits the response of the request permission to the terminal 1B. If the father (U1) has not permitted the request, note that the response of the non-permission is transmitted to the terminal 1B.

According to the above-described fifth modification example (FIGS. 20 and 21), the secondary user terminal can also issue the operation instruction to the vehicle on the basis of the permission from the primary user terminal, and therefore, this is highly convenient. Note that a method for determining the primary and the secondary in the above-described fifth modification example may be as follows. The user (such as the father who is the first user U1) who is the owner of the specific vehicle registers the key information that is the vehicle key (for example, FIG. 11). The user who is the owner of the specific vehicle and the terminal 1A are set as the primary (primary user terminal) in the key group management information 400. In this case, the key information is particularly primary key information. Further, the other user terminal (such as the terminal 1B of the mother who is the second user U2) than the primary of the group using the specific vehicle is set as the secondary (secondary user terminal). The secondary user terminal receives the permission from the primary user terminal (which may be the key information server 600), and acquires secondary key information generated on the basis of the primary key information.

In the key group management information 400 or the operation setting information 500, a user terminal that is a destination of the permission acquirement in the above-described fifth modification example may be settable. In a default setting, the primary user terminal is set as the destination of the permission acquirement. In a user setting, a user terminal other than the primary may be set as the destination of the permission acquirement. For example, the terminal of the mother (U2) that is the secondary is set as the destination of the permission acquirement in the terminal of the child.

Further, the primary user terminal that has received the operation instruction permission request from the secondary user terminal may partially change the content of the request on the basis of the user input operation, and transmit the changed information to the secondary user terminal or the in-vehicle apparatus 200.

Further, only the primary user terminal of the group may have the privilege (setting privilege) to set the key group management information 400 or the operation setting information 500 including the ranking information about the secondary user terminal or the like. A similar function to this can also be achieved by an operation setting related to the operation item “setting”. In this case, the secondary user cannot change the ranking information and the operation setting information if being not permitted from the primary user.

In another modification example, note that the mode-ON secondary user terminal can transmit the operation instruction when being permitted from the mode-OFF primary user terminal.

### Second Embodiment

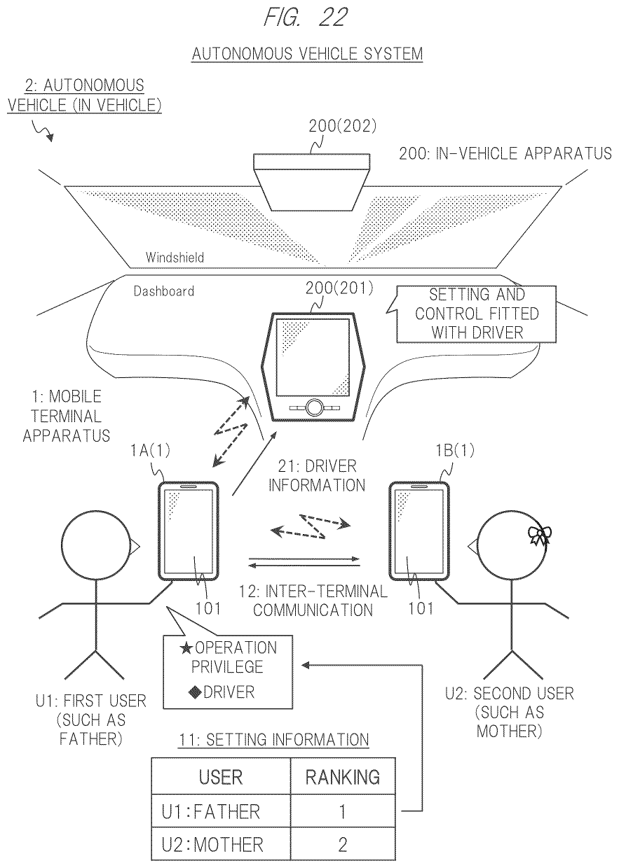

A mobile terminal apparatus according to a second embodiment will be explained with reference to FIG. 22 and subsequent drawings. A basic configuration in the second embodiment is similar to that in the first embodiment. Different components in the second embodiment from those in the first embodiment will be mainly explained below. In the second embodiment, a case of application the present invention is applied to the partially autonomous vehicle will be particularly explained such that single driver partially manually performs the driving operation. The mobile terminal apparatus 1 according to the second embodiment illustrated in FIG. 22 and the like has the cooperative function as similar to the first embodiment, and the operation privilege is determined on the basis of the ranking information of the setting information 11 by the inter-terminal communication 12 among the user terminals of the group. Further, in the second embodiment, single driver having the operation privilege is determined. Then, the mobile terminal apparatus 1 of the driver having the operation privilege transmits driver information 21 to the in-vehicle apparatus 200. The in-vehicle apparatus 200 sets and controls the autonomous vehicle 2 to be fitted with the driver on the basis of the driver information 21.

FIG. 22 illustrates the outline of the second embodiment. An example of FIG. 22 illustrates a case where two users (U1 and U2) are riding on the vehicle A (autonomous vehicle 2) that is the partially autonomous vehicle as similar to FIG. 1. In this example, through the inter-terminal communication 12, it is determined that the terminal 1A of the father who is the first user U1 has the operation privilege the on the basis of the ranking information of the setting information 11. Then, the terminal 1A of the father having the operation privilege automatically transmits the driver information 21 to the in-vehicle apparatus 200. By using the driver information 21, the in-vehicle apparatus 200 automatically performs the setting and control for operating and driving (automatically driving or manually driving) the autonomous vehicle 2 performed by the father and the terminal 1A. As examples of the setting and control, adjustment of the seat fitted with the driver, adjustment of the sensor/camera and the like are exemplified.

### [Driver Information]

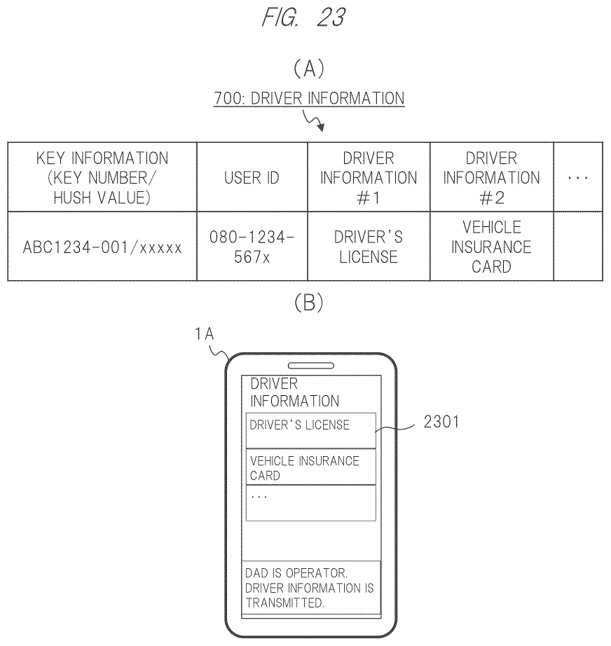

FIG. 23 illustrates a configuration example of the driver information 21. In this example, the digitized driver information 21 is included in the mobile terminal apparatus 1 of the user. FIG. 23A illustrates an example of a table of driver information 700 corresponding to the driver information 21 and stored in the mobile terminal apparatus 1. The driver information 21 is associated with the vehicle key or the like. For example, the driver information 21 is stored in the secure element 116 (FIG. 6) in the mobile terminal apparatus 1.

A system including the mobile terminal apparatus 1 stores and manages the driver information 700 as a part of the key group management information 400 or to be associated with the key group management information 400. In the table of the driver information 700 illustrated in FIG. 23A, one or more pieces of the driver information are stored to be associated with the key information and the user ID of the key group management information 400. For example, driver information #1 is driver's license information, and driver information #2 is vehicle insurance information.

Further, if the digitized driver information is included in the vehicle key device, the IC card or another type of device possessed by the user, the driver information 21 may be acquired in the mobile terminal apparatus 1 by communication via a predetermined communication interface between the device and the mobile terminal apparatus 1. Further, if the driver information 21 (such as driver's license information) is managed by a predetermined application software, the mobile terminal apparatus 1 may refer to the driver information 21 in cooperation with the application software. Further, if the driver information 21 is stored and managed in an external system such as the cooperative server 601 or the key information server 600 on the communication network 602 illustrated in FIG. 11, the mobile terminal apparatus 1 may acquire the driver information 21 by communicating with the server.

Information about a driver's license, information about an automobile insurance, information about an automobile inspection, attributional information of the user, biometric information of the user, and the like are applicable to the driver information 21. The driver information 21 includes information enabling the individual user to be identified. As the user attributional information, for example, values of sex, age, height, weight, vision acuity, and the like are exemplified. The user biometric information may include information (such as a facial image, an eye image, and fingerprint information) that can be used for biometric identification. The driver information 21 may further include heath information such as medical check-up result information, vital information (dynamic and time-series data of heartbeat, pulsation, blood pressure or the like) measured by a wearable terminal, or the like. The vital information enables a state of the person to be estimated, and therefore, can be reflected on the vehicle setting or the like.

The driver information 21 may include information about other types of identity verification certificate (such as a health insurance card and an individual (my) number card). The driver information 21 may further include user's driving history information or the like. The driving history information is information about a history of the specific vehicle having been used/driven by the user, and information recorded by the in-vehicle apparatus 200 may be used as this information. The driver information 21 may further include driver information having been set on the screen of the mobile terminal apparatus 1 by the user, in other words, vehicle setting information of the individual user. This vehicle setting information may have a user setting value for a settable item prepared by the vehicle side (such as the in-vehicle apparatus 200). For example, a setting value of a suitable sheet position for the individual user or the like is exemplified.

FIG. 23B illustrates a display example of the driver information 21 on the screen of the touch panel of the mobile terminal apparatus 1. In a default setting, the mobile terminal apparatus 1 does not display the driver information 21 but automatically transmits the driver information 21 to the in-vehicle apparatus 200. The mobile terminal apparatus 1 may display the driver information 21 on the screen after, for example, being determined to have the operation privilege in accordance with the user setting or the like, and display a message indicating that the driver information 21 is transmitted to the in-vehicle apparatus 200, or may transmit the driver information 21 in response to pressing of a confirmation button performed by the user. In the mobile terminal apparatus 1, the driver information 21 may be displayed and confirmed as described above in response to the user operation at any time. In this example, a list of the driver information is displayed on the screen. Each of driver information items 2301 in the list is an item for each individual driver information such as driver's license information or vehicle insurance information. In a default setting, all pieces of the driver information in the list are transmitted to the in-vehicle apparatus 200. Further, details can be confirmed in accordance with a selective operation for each of the driver information items 2301 in the list.

Further, the driver information to be transmitted to the in-vehicle apparatus 200 may be selectable in accordance with an operation for selecting the driver information item 2301 performed on the screen by the user. Further, as one of user settings of the mobile terminal apparatus 1, it may be settable on the screen whether or not the driver information 21 related to the function in the second embodiment can be transmitted. Alternatively, it may be settable whether or not the information can be transmitted for each of the driver information items 2301.

### [Processing Sequence]

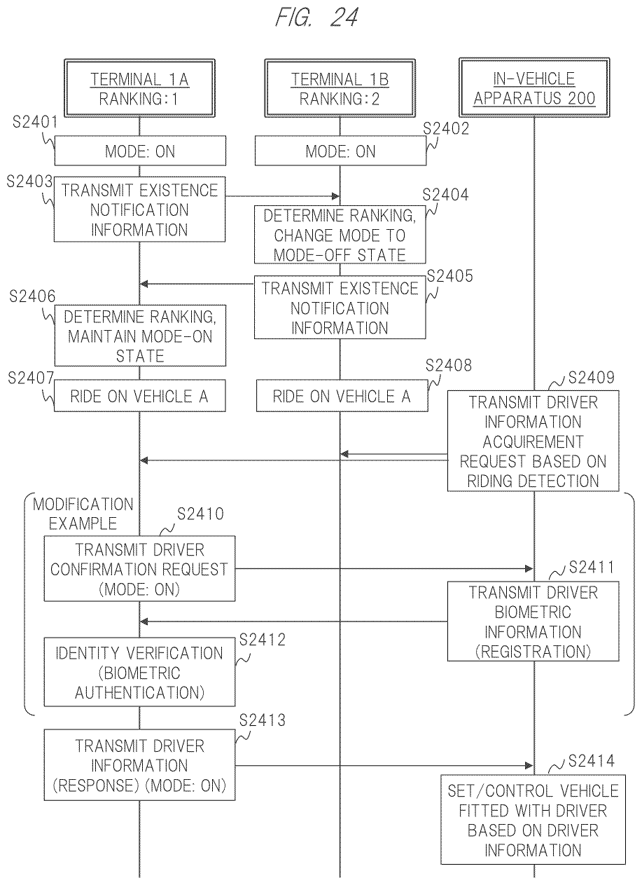

FIG. 24 illustrates an example of a processing sequence using the driver information among the terminal 1A of the first user U1 (father), the terminal 1B of the second user U2 (mother), and the in-vehicle apparatus 200 of the vehicle A in the second embodiment. Steps S2401 to S2408 are similar to steps S801 to S808 illustrated in FIG. 8. That is, through the inter-terminal communication 12, the mode of the terminal 1A of the first user U1 (father) is turned to the mode ON state with the operation privilege, and the mode of the terminal 1B of the second user U2 (mother) is turned to the mode OFF state without the operation privilege.

In steps S2407 and S2408, the two users (U1 and U2) ride on the vehicle A. In step S2409, the in-vehicle apparatus 200 detects the riding. By using, for example, a sensor (which may be, for example, a door sensor, a pressure sensor, or a camera), the in-vehicle apparatus 200 detects that the user has been seated. On the basis of the riding detection, the in-vehicle apparatus 200 transmits a driver information acquirement request to each of the user terminals detected in the vehicle A. This driver information acquirement request is a request to acquire the driver information from the user terminal. This request may be transmitted in a form of, for example, a broadcast within a predetermined range via a predetermined near field communication interface. Each of the user terminals receives the request.

In step S2409, not the riding detection but a notification from the mobile terminal apparatus 1 may be performed. A sequence from step S2410 to step S2412 is based on an additional function in a modification example, and will be described later. In a basic configuration of the second embodiment, this sequence is eliminated.

In step S2413, the terminal 1A of the first user U1 (father) is in the mode ON state with the operation privilege, and therefore, transmits the driver information 21 corresponding to the first user U1 as a driver information acquirement response to the in-vehicle apparatus 200. Note that the terminal 1B of the second user U2 (mother) is in the mode OFF state without the operation privilege, and therefore, does not transmit the driver information. The in-vehicle apparatus 200 receives the response including the driver information 21 from the terminal 1A of the first user U1.

In step S2414, by using the driver information 21 received and acquired from the terminal 1A, the in-vehicle apparatus 200 automatically sets and controls the vehicle A that is the autonomous vehicle 2 to be fitted with the attribution and the state of the driver indicated by the driver information 21. For example, as a setting for the vehicle A, a sheet position, an alarm, an air conditioner, and the like are set. Further, an orientation of the camera of the sensor 202 (FIG. 22) or the like is set. Further, a vehicle control mode (such as a highest speed limit, closure of a VSC switch or the like) related to the partially autonomous driving can be adjusted. As a result, convenient PEPS (passive entry, passive start) is achieved.

Then, the user terminal of the driver (such as the first user U1) can use the operation instruction on the operation menu screen as similar to the first embodiment, in addition to the manual driving operation. On the screen, the operation instruction corresponding to the partially autonomous driving is allowed. The function of the second embodiment can be used together with the function of the first embodiment.

The second embodiment additionally includes a function for automatic setting and control using the above-described driver information 21. As a result, the driver can be automatically determined in the group at the time of riding, and the suitable setting or the like fitted with the driver can be automatically and quickly performed. In an example different from the example illustrated in FIG. 24, when only the second user U2 (mother) rides on the vehicle A, the mother is determined as the driver in a state where the terminal 1B of the mother has the operation privilege. Then, the in-vehicle apparatus 200 sets the vehicle A or the like to be fitted with the mother who is the driver, by using the driver information received from the terminal 1B of the mother.

Note that the in-vehicle apparatus 200 of the autonomous vehicle 2 or an external system may store copy data of the driver information 21 (such as driver's license information) in the mobile terminal apparatus 1 of the user. This is effective for a countermeasure against, for example, a case of the running out of battery of the mobile terminal apparatus 1. In this case, for example, step S2409 illustrated in FIG. 24 or the like includes a step of confirmation from the in-vehicle apparatus 200 to the user terminal to confirm whether or not the driver information stored in the in-vehicle apparatus 200 or the like can be used.

### [Output of State Related to Driver Information]

Further, when the transmission of the driver information 21 is set to “Enabled”, the mobile terminal apparatus 1 in the second embodiment performs an output for notifying the user who is the owner of the terminal itself of whether or not this user has been determined to be the driver (in other words, of a driver determination result determined by the mobile terminal apparatus 1) as a predetermined output at a predetermined time point. The predetermined time point is a time point at which it has been determined that the terminal itself has the operation privilege on the basis of the inter-terminal communication 12, a time point at which it has been detected that the communication with the in-vehicle apparatus 200 is enabled, or the like. The predetermined output is, for example, a predetermined audio output, and the configuration example of the first embodiment illustrated in FIG. 15 is similarly applicable thereto.

For example, the mobile terminal apparatus 1 outputs a predetermined musical scale (such as “Do Mi So in Japanese (C E G in English) [symbol] ”) when it is determined that the user of the terminal itself is single driver having the operation privilege. Further, the mobile terminal apparatus 1 may also output the same audio when the setting state of the transmission of the driver information 21 in the terminal itself is changed from the state “Disabled” to the state “Enabled” (changed from the mode-OFF state to the mode-ON state). Further, the mobile terminal apparatus 1 may output a different predetermined musical scale (such as “So Mi Do in Japanese (G E C in English) [symbol] ”) when the state of the user of the terminal itself is changed to the state without the operation privilege, in other words, when it is determined that the user is not the driver. Further, the mobile terminal apparatus 1 may also output the same audio when the setting state of the transmission of the driver information is changed from the state “Enabled” to the state “Disabled” (changed from the mode-ON state to the mode-OFF state). In the case of the audio output, the user can easily confirm and recognize the result of the determination of whether or not the owner of the mobile terminal apparatus 1 has been determined to be the driver without the need to check the screen.

### Effect and Others

As described above, according to the second embodiment, when the user of the group rides on the specific vehicle, the driver can be determined on the basis of the operation privilege and the driver information, and can smoothly shift to the driving by performing the vehicle setting fitted with the driver or the like.

Note that the driver information 21 can also be transmitted to a different vehicle if the mobile terminal apparatus 1 stores this driver information 21. For example, when the first user U1 illustrated in FIG. 22 rides on the vehicle B different from the vehicle A, the terminal 1A of the first user U1 who is the driver transmits the driver information 21 to the in-vehicle apparatus of the vehicle B. This in-vehicle apparatus sets the vehicle B or the like by using this driver information 21. If the vehicle side has a function of receiving and setting the driver information 21 or the like as the function of the second embodiment, the function is also applicable to cases of a rental car, a loaner car, a vehicle replacement and the like.

Further, the ranking information is not always set by the user but may be automatically determined by a computer. In a modification example, the mobile terminal apparatus 1 or the in-vehicle apparatus 200 stores a history in which the user of the terminal itself has been the driver, as driving history information. By using the AI processor 111 (FIG. 6), the mobile terminal apparatus 1 estimates a preferable ranking of this user in the ranking information from the history in which the user of the terminal itself has been the driver. For example, the larger the number of the histories is, or the better the driving is, the higher the ranking is. Then, the mobile terminal apparatus 1 may automatically update the setting to update the ranking in the ranking information of the setting information 11 (the key group management information 400) to the estimated ranking.

For the ranking determination based on the driving history and the estimation, the ranking may be determined in accordance with date and time or a group configuration. For example, the ranking may be determined to be different between a history in a case of the usage of the specific vehicle by two members who are the father and the mother and a history in a case of the usage of the specific vehicle by the group of four members including the child. Further, in order to determine the ranking, for example, the mobile terminal apparatus 1 or the in-vehicle apparatus 200 may recognize conversation among the occupants or the input audio of the operation instruction via the audio recognition, store this as information, and change the ranking from the estimation based on the information.

### Modification Example: Driver Status Management

### (Labor Saving of Ranking Designation)

A modification example of the second embodiment is achieved as follows. A mobile terminal apparatus according to the modification example additionally has a function of managing a state, as a driver status, indicating whether or not the owner of the mobile terminal apparatus is actually the driver at a specific time point, on the basis of information indicating whether or not the mobile terminal apparatus has actually transmitted driver information of the owner to the in-vehicle apparatus 200. Further, the mobile terminal apparatus (such as 1A) is configured to transmit the existence notification information including information about a driver status of its own terminal to the other mobile terminal apparatus (such as 1B) when transmitting the existence notification information. Further, if information about the driver status included in the existence notification information received from the other mobile terminal apparatus 1B indicates the driver, the mobile terminal apparatus 1A performs control to set a transmission setting of the driver information of the own terminal to the state “Disabled”, regardless of the ranking information. Note that the driver status may be managed by, for example, a flag showing “driver status=1 (indicating that the owner is currently the driver)” at the time of the transmission of the driver information to the in-vehicle apparatus 200 or “driver status=0 (indicating that the owner is not currently the driver)” triggered by stop of an engine of the vehicle. Alternatively, the showing of the “driver status=0” may be triggered by a change in a state of communication with the in-vehicle apparatus 200 (such as stop of a Bluetooth audio apparatus), or the showing of the “driver status=0” may be made based on predetermined communication from the in-vehicle apparatus 200.

Since the mobile terminal apparatus has the above-described function of managing the driver status, labor for the operation for changing the ranking information of the mobile terminal apparatus required when the number of occupants has increased during driving or when the driver is changed under a specific situation can be partially saved. In such a scene that the mother drives and picks up the father at a station, when the mother who has driven from home puts the father onto a passenger seat and drives home while using the mobile terminal apparatus as it is, the ranking of the mobile terminal apparatus 1B of the mother who has first ridden on the vehicle and became the driver is 2, but the driver status is “driver status=1”. When the vehicle arrives at the station in this state, the mobile terminal apparatus 1A of the father receives the existence notification information of the mobile terminal apparatus 1B of the mother, and detects that the driver status of the mobile terminal apparatus 1B is “driver status=1”. Although the ranking of the mobile terminal apparatus 1A is 1 that is higher than that of the mobile terminal apparatus 1B, the transmission setting of the driver information of the own terminal (1A) is set to “Disabled” (the mode-OFF state) because the status of the mobile terminal apparatus 1B is “driver status=1”. On the other hand, although the mobile terminal apparatus 1B detects the mobile terminal apparatus 1A having the higher ranking than that of its own terminal possessed by the father at the time of the arrival of the vehicle at the station, the mobile terminal apparatus 1B does not perform the ranking determination processing, and the state “Enabled” (the mode-ON state) of its transmission setting of the driver information remains unchanged because the status of the own terminal is “driver status=1”. As a result, the mobile terminal apparatus 1B of the mother continues to be the mobile terminal apparatus of the actual driver, and therefore, time and effort for the mother or the father to perform the operation for changing the ranking information are saved. Further, a match between the user who is actually driving and the user corresponding to the driver information received by the vehicle is kept.

On the other hand, when the father takes over the driving from the mother at the station, for example, when the father takes over the driving from the mother after the engine stop operation of the vehicle, the mobile terminal apparatus 1B of the mother is reset to “driver status=0” by the engine stop operation, and then, the ranking is determined for both the mobile terminal apparatuses of the father and the mother, and the state of the transmission setting of the driver information of the mobile terminal apparatus 1A of the father having the higher ranking is set to “Enabled” (the mode-ON state), and therefore, the driver information is transmitted from the mobile terminal apparatus 1A of the father. Therefore, the father or the mother can smoothly take over the driving without performing the operation of each mobile terminal apparatus when taking over the driving, and the match between the user who is actually driving and the user corresponding to the driver information received by the vehicle is kept.

### Modification Example: Identity Verification

A modification example of the second embodiment is achieved as follows. A mobile terminal apparatus according to the modification example additionally has a function of identity verification described below in addition to the functions of determining the driver and setting the vehicle based on the driver information 21 as described above. This identity verification is for verifying that a user determined as the driver is really the user himself/herself, on the basis of the operation privilege. In the modification example, in a sequence from steps S2410 to S2412 illustrated in FIG. 24, the user terminal and the in-vehicle apparatus 200 cooperate with each other through communication to perform biometric identification using biometric information of the user, and therefore, the identity verification related to the driver is performed.

In step S2410 illustrated in FIG. 24, the terminal 1A of the first user U1 (father) in the mode-ON state that has received the driver information acquirement request transmits the driver confirmation request to the in-vehicle apparatus 200, and the in-vehicle apparatus 200 receives the request. In step S2411, as a driver confirmation response, to the terminal 1A, the in-vehicle apparatus 200 transmits the biometric information (such as fingerprint information) of the user registered on the in-vehicle apparatus 200 side and used for confirming the driver identification, and then, the terminal 1A receives the response.

In step S2412, the terminal 1A performs the biometric identification (such as fingerprint identification) for the identity verification using the biometric information received from the in-vehicle apparatus 200 and the biometric information included in the terminal itself. The biometric information included in the terminal itself is, for example, fingerprint information acquired from the user at the time of the terminal unlocking by using a fingerprint identification function (which may alternatively be a face identification function using a front camera (in-camera) to be used at the time of the terminal unlocking. The terminal 1A compares the biometric information, and determines a result of the biometric identification. To the user, the mobile terminal apparatus 1 outputs the result of the biometric identification, such as a result of the driver confirmation.

If the result of the above-described biometric identification indicates success, in other words, if the user has been identified as the user himself/herself, a sequence in step S2413 and subsequent steps is validated. If the result indicates failure, in other words, if the user has not been identified as the user himself/herself, the sequence is invalidated.

In this example, the case of the identification processing on the mobile terminal apparatus 1 has been described. However, the present invention is not limited to this example, and the identification processing may be performed on the in-vehicle apparatus 200. In this case, for example, the in-vehicle apparatus 200 transmits the request of the biometric information to the terminal 1A, the terminal 1A transmits biometric information for a challenge to the in-vehicle apparatus 200, and the in-vehicle apparatus 200 compares the biometric information acquired from the terminal 1A with the biometric information registered on the in-vehicle apparatus 200, and then, determines the result of the biometric identification.

In the above-described example, the case of the identity verification for single driver in the partially autonomous vehicle has been described. However, the preset invention is not limited to this, and identification of whether or not the occupant in the fully autonomous vehicle is the legitimate user (such as the owner of the terminal having the cooperative function in the first embodiment) may be verified. Note that the biometric information included as one of the driver information and the above-described biometric information for the biometric identification are different from each other. However, the biometric information included as one of the driver information may be used as the above-described biometric information for the biometric identification.

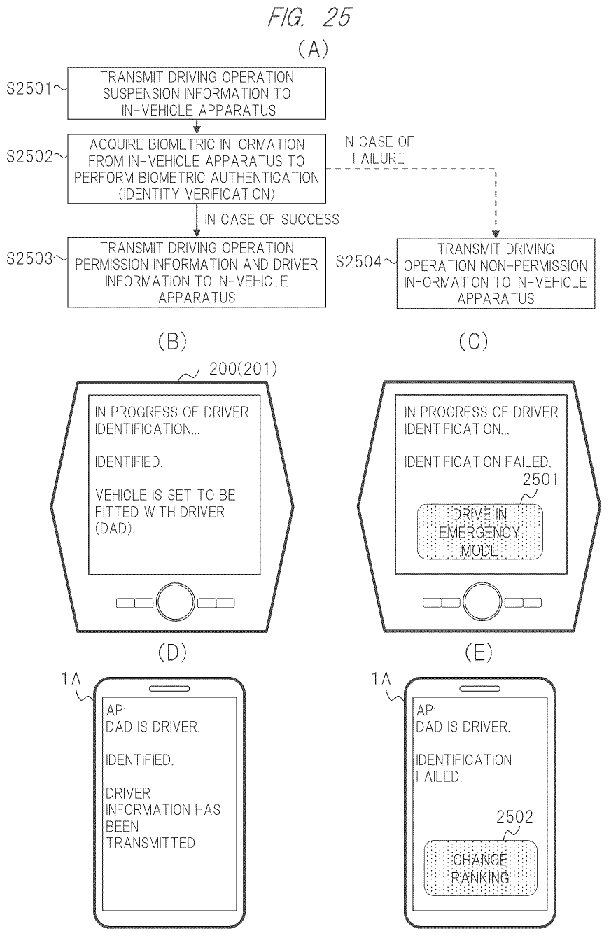

FIG. 25 illustrates an operation example of the identity verification (identification processing) in the above-described modification example. FIG. 25A in illustrates an example of a processing flow of the identity verification on the mobile terminal apparatus 1. In step S2501, the mobile terminal apparatus 1 transmits driving operation suspension information to the in-vehicle apparatus 200. When receiving this driving operation suspension information, the in-vehicle apparatus 200 shifts to a state where an operation related to driving (such as reception of the operation instruction) is temporarily suspended.

In step S2502, as described above in the sequence, the mobile terminal apparatus 1 performs the biometric identification for identifying the driver by using the biological information received from the in-vehicle apparatus 200. If the result of the identification indicates the success, the process flow proceeds to step S2503 such that the mobile terminal apparatus 1 transmits driving operation permission information and the driver information of step S2413 to the in-vehicle apparatus 200. If the result of the identification indicates the failure, the process flow proceeds to step S2504 such that the mobile terminal apparatus 1 transmits driving operation non-permission information to the in-vehicle apparatus 200.

When receiving the driving operation permission information from the mobile terminal apparatus 1 in step S2503, the in-vehicle apparatus 200 outputs information indicating that the driver has been identified as the driver himself/herself or information indicating the driving operation permission to the user, for example, on the screen of the touch panel 201 (FIG. 22). FIG. 25B illustrates an example of the screen of the touch panel 201 (FIG. 22) of the in-vehicle apparatus 200 in the case of the success, and the screen display shows that the driver has been identified (verified) as the driver himself/herself or information indicating that the vehicle A is set to be fitted with the driver (such as the father). Further, FIG. 25D illustrates an example of the screen of the mobile terminal apparatus 1 (such as the terminal 1A of the father) in the case of the success, and the screen display shows that the father has been determined as the driver, shows that the driver has been identified (verified) as the driver himself/herself, and shows that the driver information has been transmitted.

When receiving the driving operation non-permission information from the mobile terminal apparatus 1 in step S2504, the in-vehicle apparatus 200 outputs information indicating that the driver has not been identified as the driver himself/herself or information indicating the driving operation non-permission to the user, for example, on the screen of the touch panel 201 (FIG. 22). FIG. 25C illustrates an example of the screen of the touch panel 201 (FIG. 22) of the in-vehicle apparatus 200 in the case of the failure, and the screen display shows that the driver has not been identified (verified) as the driver himself/herself or information indicating and shows a button 2501 for driving in the emergency mode as the countermeasures.

The autonomous vehicle 2 including the in-vehicle apparatus 200 that has received the driving operation suspension information and the driving operation non-permission information does not start (or its engine is not started) until it receives the driving operation permission information. Alternatively, the in-vehicle apparatus 200 allows the driving in the emergency mode when the button 2501 is pressed. The emergency mode is one of control modes related to autonomous driving. In the emergency mode, the autonomous vehicle 2 is controlled to travel with, for example, high beam while turning on hazard light. As a result, an effect of preventing unauthorized driving and terminal theft can be expected, and substitute driving in a real emergency situation is also achieved.

Further, FIG. 25E in illustrates an example of the screen of the mobile terminal apparatus 1 (such as the terminal 1A of the father) in the case of the failure, and the screen display shows that the father has been determined as the driver, that the driver has not been identified (verified) as the user himself/herself, and shows a button 2502 for changing the ranking as countermeasures. When the button 2502 is pressed, the mobile terminal apparatus 1 shifts to a screen for setting and updating the ranking information of the key group management information 400 to change the ranking of the user of the terminal itself. As another countermeasures, the operation privilege may be given to the other user terminal having the highest ranking excluding the ranking of the user who has been failed to be identified, and the other user may be determined as the driver.

Note that on/off of the above-described function of the identity verification may also be set by the user setting.

Further, a modification example may further include determination of the qualification of the driving (or the operation instruction) performed by a person, along with the above-described driver determination or identity verification. By using the driver information 21 of the user, the mobile terminal apparatus 1 or the in-vehicle apparatus 200 may confirm and determine whether or not the user has been qualified as the driver. For example, in step S2414 illustrated in FIG. 24, the in-vehicle apparatus 200 may further determine the qualification for the driver and notify the user terminal of a determination result. When determining that the driver under the driver's attribution, state or the like indicated by the driver information 21 is not qualified as the driver of the autonomous vehicle 2, the in-vehicle apparatus 200 may notify the user terminal of the determination, and control the travelling of the vehicle not to be allowed, control the operation instruction not to be allowed, or control the travelling of the vehicle under the driving limit mode.

For example, the qualification may be determined based on confirmation of whether or not the driver's license information has expired, or the qualification may be determined based on the driving history information.

Similarly, the cooperative function in the first embodiment may additionally include the determination of the qualification as a requirement and preprocessing for giving the operation privilege to the user. For example, after it is determined, based on the ranking information, that the operation privilege is given, the step of the determination of the qualification using the driver information 21 is added. The operation privilege is given to the user terminal that has been determined to be qualified.

### Third Embodiment

(Driver Identification Using Method Different from Ranking Information)

In the above-described second embodiment, in the case of the usage of the partially autonomous vehicle among the plurality of users, the operation privilege is determined, in other words, it is determined who is the driver among the plurality of users, by the method using the ranking information. Meanwhile, the partially autonomous vehicle is generally provided with a plurality of seats, one of the seats is a driver's seat, and the user who is the driver is seated on the driver's seat. In consideration of this point, it may be determined who is the driver among the plurality of users ridden on the vehicle, by the following method. Note that a basic configuration in a third embodiment is similar to that in the first embodiment or second embodiment, and different components in the third embodiment from those in the other embodiments will be mainly explained below.

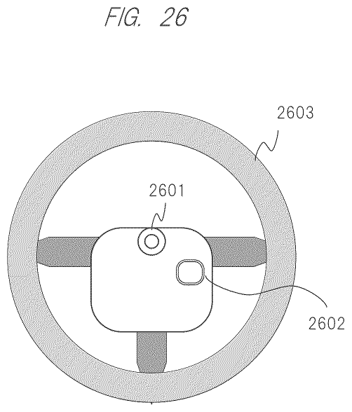

As a first example of the third embodiment, the driver may be identified on the basis of the biometric information of the user who has actually been seated on the driver's seat. The vehicle is provided with a biometric sensor that acquires the biometric information. As the type of the biometric sensor, for example, a camera and a fingerprint sensor may be used depending on the biometric information to be acquired when a shape of a face is acquired and when a fingerprint is acquired, respectively. And, as a setting position of the biometric sensor, for example, the biometric sensor may be set in a steering 2603 provided in the driver's seat as illustrated in FIG. 26. In FIG. 26, a term 2601 denotes the camera, and a term 2602 denotes the fingerprint sensor. Note that the camera 2601 may be a camera capable of capturing images with not only visible light but also infrared light. And, the biometric information acquired by the biometric sensor is transmitted to the mobile terminal apparatus 1 via the communication interface of the in-vehicle apparatus 200. A format of the biometric information to be transmitted may be any format if being processable on the mobile terminal apparatus 1. For example, the format may be of RAW information of the biometric information acquired by the biometric sensor or feature information acquired by extracting a feature with a predetermined algorithm on the basis of the RAW information.

The mobile terminal apparatus 1 that has received the biometric information from the in-vehicle apparatus 200 determines, on the basis of the received biometric information, whether or not the user who has the received biometric information is the user of its own terminal. In determination processing, the biometric information received from the in-vehicle apparatus 200 may be compared with biometric information (or its feature information) acquired by the sensor of the mobile terminal apparatus 1 and registered in the mobile terminal apparatus 1. Then, if it is determined that the user who has the biometric information received from the in-vehicle apparatus 200 is the owner user of the own terminal, an ACK signal indicating that the users have matched each other is transmitted to the in-vehicle apparatus 200. Further, in the transmission of the ACK signal, the driver information of the owner user may be together transmitted. If it is determined that the user who has the biometric information received from the in-vehicle apparatus 200 is not the owner user of the own terminal, note that a NACK signal indicating that the determination is “negative” is transmitted to the in-vehicle apparatus 200. Further, a vehicle that has received the NACK signal from any mobile terminal apparatus existing in the vehicle may perform control to, for example, block an engine start function, display a warning, or turn on the hazard light.

The user who has been seated on the driver's seat can be identified when the in-vehicle apparatus 200 and the mobile terminal apparatus 1 described above are operated in, for example, the following procedure. For example, when detecting that the user has been seated on the driver's seat, the in-vehicle apparatus 200 of the vehicle acquires the biometric information of the seated user by using the biometric sensor. Then, a driver determination request signal including the acquired biometric information is transmitted to each of the mobile terminal apparatuses 1 in the vehicle. Each of the mobile terminal apparatuses that have received the driver determination request signal determines whether or not the user is the owner user of its own terminal, on the basis of the biometric information received by each of them. Then, each of the mobile terminal apparatuses 1 in which the determination processing has been finished transmits the ACK signal or the NACK signal to the in-vehicle apparatus 200. Accordingly, even if the plurality of mobile terminal apparatuses receive the driver determination request signal, the number of the mobile terminal apparatuses having the result of the user determination based on the biometric information that the user is the owner user is basically only one. Therefore, it can be identified who is the user seated on the driver's seat.

According to the above-described method, it is unnecessary to previously register the biometric information of the user who is the driver into the in-vehicle apparatus 200 of the vehicle. Accordingly, the driver can start to smoothly drive even a vehicle on which the user rides at the first time (such as the usage of the rental car or the purchase and replacement of the private car).

Further, the mobile terminal apparatus that has transmitted the ACK signal may acquire the biometric information from the in-vehicle apparatus 200 at a predetermined time interval after transmission of the ACK signal, and may continuously determine that the user on the driver's seat is the owner user of the own terminal, for example, until the engine stop is detected or during the travelling of the vehicle. This can suppress such a pretense (impersonation) action that the user who has the driver's license allows a user who has no driver's license to drive the vehicle. Note that a procedure for acquiring the biometric information at predetermined time interval after the transmission of the ACK signal may have a configuration in which the mobile terminal apparatus 1 transmits the acquirement request signal of the biometric information to the in-vehicle apparatus 200 of the vehicle or a configuration in which the in-vehicle apparatus 200 transmits the driver determination request signal including the biometric information to the mobile terminal apparatus 1.

Next, as a second example, the mobile terminal apparatus of the driver may be identified on the basis of a position of the mobile terminal apparatus owned by the occupant user in the vehicle and a seating situation of the user. As a location where the user who is the driver places the mobile terminal apparatus owned by himself/herself when driving, there are various cases such as a case where it is put into a pocket of a shirt or a jacket worn by the user, a case where it is put in a door pocket of the driver's seat of the vehicle, a case where it is put on a backseat while being in a bag, and a case where it is put on a center console or a dashboard. On the other hand, it is considerable that a user who is not the driver often puts the mobile terminal apparatus near this user to be able to use it even during the traveling. Therefore, the mobile terminal apparatus of the user who is the driver may be identified on the basis of respective positions of a plurality of mobile terminal apparatuses in the vehicle and the seating situations of the users on a plurality of seats.

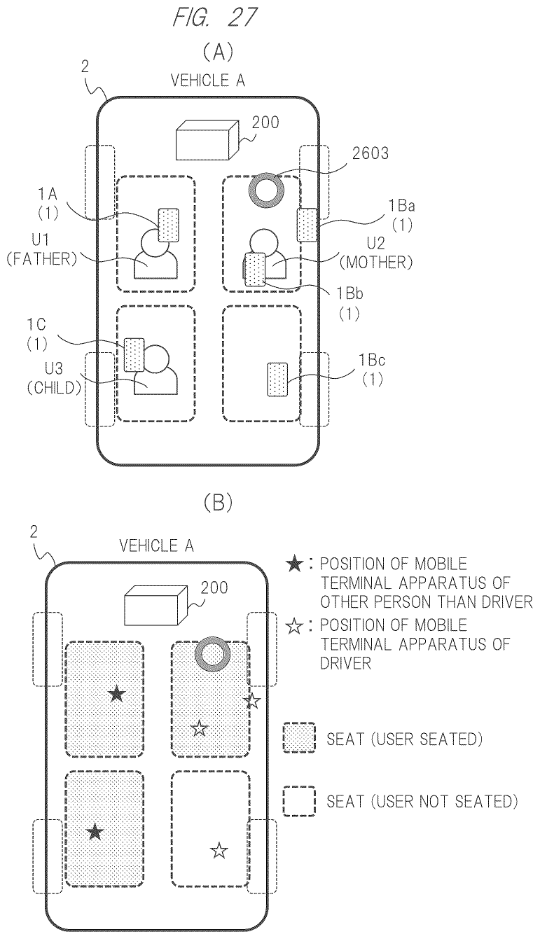

FIG. 27A is a diagram illustrating an example of the users riding on the vehicle, the respective positions of the mobile terminal apparatuses owned by the users, and the seating positions of the users. It is considerable that the mobile terminal apparatus 1B owned by the user U2 (mother) who is the driver is put on various locations as described above illustrated as, for example, 1Ba to 1Bc in FIG. 27A. On the other hand, it is considerable that the mobile terminal apparatuses 1A and 1C respectively owned by the user U1 (father) and the user U3 (child) who are simultaneously riding on the vehicle but are not the driver are positioned near the seating positions of the user U1 and the user U3. FIG. 27B schematically illustrates the riding situation illustrated in FIG. 27A based on the respective positions of the mobile terminal apparatuses and the seating situation of the users.

From a positional relationship as illustrated in FIG. 27B, it is difficult to determine whether or not the mobile terminal apparatus 1B is the terminal owned by the user U2 because it is poorly associated with the driver's seat position on which the user U2 is being seated. On the other hand, respective positional relationships between the mobile terminal apparatus 1A and the user U1 and between the mobile terminal apparatus 1C and the user U3 each have a predetermined correlation. Accordingly, in the case of FIG. 27B, it can be determined that the mobile terminal apparatuses 1A and 1C are respectively the terminals of two users who are “not the driver” but are riding on the vehicle. From this determination, the remaining mobile terminal apparatus 1B can be identified as the terminal of the driver.

The in-vehicle apparatus 200 of the vehicle transmits a near field wireless wave (such as UWB wireless wave) via a plurality of antennas for the near field wireless wave not illustrated provided in the vehicle, and acquires the respective positions of the mobile terminal apparatuses existing in the vehicle by using a well-known method. Further, the mobile terminal apparatus of the driver may be identified from among the plurality of mobile terminal apparatuses in the vehicle by, for example acquiring the seating situation of the users by using the seating sensor provided on each of seats, and using the above-described identification method that is the method for identifying the mobile terminal apparatus of the user who is the driver from a result of the early determination of the respective mobile terminal apparatuses of the users other than the driver on the basis of the acquired positions of the mobile terminal apparatuses and the acquired seating situation of the users. Further, the in-vehicle apparatus 200 that has identified the mobile terminal apparatus of the driver may transmit the determination result to each of the mobile terminal apparatuses, and each of the mobile terminal apparatuses may set the state of the transmission setting of the driver information to the state “Enabled” or “Disabled” (the mode-ON state or the mode-OFF state) on the basis of the received determination result. Note that a configuration may be used in which each of the mobile terminal apparatuses acquires the respective positions of the mobile terminal apparatuses and the seating situation of the users by operating in cooperation with the in-vehicle apparatus 200 to identify the mobile terminal apparatus of the driver on the basis of the mobile terminal using the above-described identification method.

In the foregoing, the invention made by the inventors of the present application has been concretely described on the basis of the embodiments. However, the present invention is not limited to the foregoing embodiments, and various modifications and alterations can be made within the scope of the present invention. The components may be single or plural unless otherwise noted. The components in the embodiments except for the essential components may be added, removed, replaced and others. A combination of the embodiments is also applicable.

### EXPLANATION OF REFERENCE CHARACTERS

1, 1A, 1B . . . mobile terminal apparatus, 2 . . . autonomous vehicle, 11 . . . setting information, 12 . . . inter-terminal communication, 13 . . . operation instruction, 200 . . . in-vehicle apparatus

1. A mobile terminal apparatus carried by each of a plurality of users who can use an autonomous vehicle, comprising:
a controller configured to transmit an operation instruction for operating the autonomous vehicle to an in-vehicle apparatus of the autonomous vehicle; and
a storage configured to store setting information including information for identifying each user or mobile terminal apparatus and ranking information for setting a ranking related to the operation of the autonomous vehicle, among the plurality of users making a group using the autonomous vehicle and the plurality of mobile terminal apparatuses,
wherein the controller in the mobile terminal apparatus is configured to
detect a mobile terminal apparatus of other user of the group by communication with the mobile terminal apparatus of the other user,
determine, on the basis of the ranking information of the setting information referred to from the storage, whether or not the terminal itself has an operation privilege for transmitting the operation instruction while taking the terminal itself and the detected mobile terminal information of the other user as candidate user terminals, and,
if the terminal itself has the operation privilege, transmit the operation instruction to the in-vehicle apparatus on the basis of an input operation performed by the user.

2. The mobile terminal apparatus according to claim 1,
wherein the mobile terminal apparatus is configured to
transmit existence notification information to surroundings via a predetermined communication interface in the communication with the mobile terminal apparatus of the other user, and
if receiving the existence notification information of the mobile terminal apparatus of the other user from the mobile terminal apparatus of the other user, detect the mobile terminal apparatus of the other user.

3. The mobile terminal apparatus according to claim 1,
wherein the mobile terminal apparatus is configured to
performs the communication via a predetermined near field communication interface in the communication with the mobile terminal apparatus of the other user.

4. The mobile terminal apparatus according to claim 1,
wherein the mobile terminal apparatus is configured to
provide a screen of a graphical user interface enabling the ranking information to be set by the user, and,
if the ranking information is updated in a mobile terminal apparatus of a certain user, performs the communication with the mobile terminal apparatus of the other user to synchronize the setting of the ranking information.

5. The mobile terminal apparatus according to claim 1,
wherein the mobile terminal apparatus is configured to
set respective temporary rankings of the plurality of users of the group, on the basis of the input operation performed by the user, separately from the setting of the ranking information, and
determine the operation privilege on the basis of the temporary rankings.

6. The mobile terminal apparatus according to claim 1,
wherein the storage is configured to store operation setting information that sets an operation item of an operation instruction to be allowed, for each of the users of the group, and
if having the operation privilege, the mobile terminal apparatus provides an operation menu screen having the operation item of the allowed operation instruction, on the basis of the operation setting information.

7. The mobile terminal apparatus according to claim 1,
wherein the mobile terminal apparatus is configured to,
if having the operation privilege, performs a predetermined first output indicating that the mobile terminal apparatus has the operation privilege, and
if not having the operation privilege, performs a predetermined second output indicating that the mobile terminal apparatus does not have the operation privilege.

8. The mobile terminal apparatus according to claim 1,
wherein the mobile terminal apparatus is configured to,
if detecting a mobile terminal apparatus of a user different from the group, displays the mobile terminal apparatus of the different user as a guest on a screen,
add the guest into the group, on the basis of the input operation performed by the user, and
set a ranking of the guest.

9. The mobile terminal apparatus according to claim 1,
wherein the mobile terminal apparatus is configured to
perform the communication via a predetermined long-distance communication interface in the communication with the mobile terminal apparatus of the other user to detect the mobile terminal apparatus of the other user remotely connected.

10. The mobile terminal apparatus according to claim 1,
wherein the mobile terminal apparatus is configured to
acquire position information of the autonomous vehicle and position information of the terminal itself, and
if a position of the terminal itself is within a predetermined range from a position of the autonomous vehicle, take the terminal itself as the candidate user terminal.

11. The mobile terminal apparatus according to claim 1,
wherein the storage is configured to store information for setting a subordination relationship among the plurality of mobile terminal apparatuses of the plurality of users of the group,
a secondary user terminal in the subordination relationship transmits an operation instruction permission request to a primary user terminal,
if receiving the operation instruction permission request, the primary user terminal transmits an operation instruction permission response to the secondary user terminal, on the basis of a permission performed by the user, and
if receiving the operation instruction permission response, the secondary user terminal transmits the operation instruction to the in-vehicle apparatus.

12. The mobile terminal apparatus according to claim 1,
wherein the storage is configured to store information for setting a subordination relationship among the plurality of mobile terminal apparatuses of the plurality of users of the group,
a secondary user terminal in the subordination relationship transmits an operation instruction permission request to a primary user terminal, and
if receiving the operation instruction permission request, the primary user terminal transmits the operation instruction to the in-vehicle apparatus, on the basis of a permission performed by the user.

13. A mobile terminal apparatus carried by each of a plurality of users who can use a vehicle, comprising:
a controller configured to transmit information to an in-vehicle apparatus of the vehicle; and
a storage configured to store driver information of the user of the terminal itself and setting information including information for identifying each user or mobile terminal apparatus and ranking information for setting a ranking related to an operation of the vehicle, among the plurality of users making a group using the vehicle and the plurality of mobile terminal apparatuses,
wherein the controller in the mobile terminal apparatus is configured to
detect a mobile terminal apparatus of other user of the group by communication with the mobile terminal apparatus of the other user,
determine whether or not the user of the terminal itself is a driver while taking the terminal itself and the detected mobile terminal information of the other user as candidate user terminals, on the basis of the ranking information of the setting information referred to from the storage, and
if the user of the terminal itself is the driver, transmit the driver information to the in-vehicle apparatus, and causes the in-vehicle apparatus to set and control the vehicle to be fitted with the driver by using the driver information.

14. The mobile terminal apparatus according to claim 13,
wherein the driver information includes at least one of driver's license information, vehicle insurance information, vehicle inspection information, attributional information, biometric information, driving history information, and vehicle setting information prepared by a user setting.

15. The mobile terminal apparatus according to claim 13,
wherein the mobile terminal apparatus is configured to
perform identification processing for verifying an identity of the user who is the driver in cooperation with the in-vehicle apparatus, and,
if the identity of the user has been verified, causes the in-vehicle apparatus to use the driver information and set and control the vehicle to be fitted with the driver.

16. The mobile terminal apparatus according to claim 13,
wherein the mobile terminal apparatus is configured to,
if the user of the terminal itself has been determined as the driver, perform a predetermined output indicating that the user of the terminal itself has been determined as the driver.

17. The mobile terminal apparatus according to claim 13,
wherein the mobile terminal apparatus is configured to
transmit existence notification information to surroundings via a predetermined communication interface in the communication with the mobile terminal apparatus of the other user, and
if receiving the existence notification information of the mobile terminal apparatus of the other user from the mobile terminal apparatus of the other user, detect the mobile terminal apparatus of the other user.

18. The mobile terminal apparatus according to claim 17 further comprising
driver status information indicating whether or not the driver information has been transmitted to the in-vehicle apparatus after the user of the terminal itself has been determined as the driver,
wherein the mobile terminal apparatus is configured to
transmit the driver status information to be included in the existence notification information, and
determine whether or not the user of the terminal itself is the driver on the basis of the driver status information of the mobile terminal apparatus of the other user to be included in the existence notification information received from the mobile terminal apparatus of the other user.

19. A mobile terminal apparatus carried by each of a plurality of users who can use a vehicle, comprising:
a controller configured to transmit/receive information to/from an in-vehicle apparatus of the vehicle; and
a storage configured to store biometric information of the user who is an owner of the mobile terminal apparatus,
wherein the controller of the mobile terminal apparatus is configured to,
from the in-vehicle apparatus, receive the biometric information of the user seated on a driver's seat of the vehicle,
determine whether or not the user seated on the driver's seat of the vehicle is the user who owns the mobile terminal apparatus, on the basis of the received biometric information and the biometric information stored in the storage,
transmit a result of the determination to the in-vehicle apparatus, and,
by using the result of the determination, cause the in-vehicle apparatus to identify which of the mobile terminal apparatuses respectively carried by the users is the mobile terminal apparatus of the user seated on the driver's seat.

20. The mobile terminal apparatus according to claim 19,
wherein the mobile terminal apparatus is configured to,
if the vehicle is traveling, repeatedly receive the biometric information of the user seated on the driver's seat of the vehicle at a predetermined time interval,
determine whether or not the received biometric information and the biometric information stored in the storage match each other, and
transmit a result of the determination to the in-vehicle apparatus.

21. A method of identifying a mobile terminal apparatus owned by a user who is a driver from among a plurality of mobile terminal apparatuses existing in a vehicle that can be used by a plurality of users, the method comprising:
as steps to be performed by a controller provided in an in-vehicle apparatus of the vehicle,
a step of transmitting a predetermined near field wireless wave from the in-vehicle apparatus a plurality of times, receiving information about the near field wireless wave transmitted the plurality of times, from each of the plurality of mobile terminal apparatus, and measuring respective positions of the plurality of mobile terminal apparatus on the basis of the received information about the near field wireless wave;
a step of acquiring a seating situation of the user on the basis of a result of detection in a seating sensor provided in the vehicle; and
a step of identifying the mobile terminal apparatus owned by the user who is the driver, on the basis of the measured position of the mobile terminal apparatus and the acquired seating situation.

22. The method of identifying the mobile terminal apparatus according to claim 21,
wherein the step of identifying the mobile terminal apparatus includes:
a step of identifying the mobile terminal apparatus owned by the user seated on a seat other than a driver's seat, on the basis of the respective measured positions of the plurality of mobile terminal apparatus and the acquired seating situation; and
a step of identifying the mobile terminal apparatus owned by the user seated on the driver's seat.

23. A method of operating an autonomous vehicle in an autonomous vehicle system including mobile terminal apparatuses respectively carried by a plurality of users who can use the autonomous vehicle,
each of the mobile terminal apparatus including:
a controller configured to transmit an operation instruction for operating the autonomous vehicle to an in-vehicle apparatus of the autonomous vehicle; and
a storage configured to store setting information including information for identifying each user or mobile terminal apparatus and ranking information for setting a ranking related to the operation of the autonomous vehicle, among the plurality of users making a group using the autonomous vehicle and the plurality of mobile terminal apparatus,
the method comprising:
as steps to be performed by the controller of the mobile terminal apparatus,
a step of detecting the mobile terminal apparatus of the other user of the group by communication with the mobile terminal apparatus of the other user;
a step of determining whether or not the terminal itself has an operation privilege for transmitting the operation instruction while taking the terminal itself and the detected mobile terminal apparatus of the other user as candidate user terminals, on the basis of the ranking information of the setting information referred to from the storage; and
if the mobile terminal apparatus has the operation privilege, a step of transmitting the operation instruction to the in-vehicle apparatus, on the basis of an input operation performed by the user.

24. A method of transmitting information in a cooperative system between a mobile terminal apparatus carried by each of a plurality of users and a vehicle that can be used by the plurality of users,
each of the mobile terminal apparatus including:
a controller configured to transmit information for controlling the vehicle to an in-vehicle apparatus of the vehicle; and
a storage configured to store driver information of the user of the terminal itself and setting information including information for identifying each user or mobile terminal apparatus and ranking information for setting a ranking related to the operation of the vehicle, among the plurality of users making a group using the vehicle and the plurality of mobile terminal apparatus,
the method comprising:
as steps to be performed by the controller of the mobile terminal apparatus,
a step of detecting the mobile terminal apparatus of the other user of the group by communication with the mobile terminal apparatus of the other user;
a step of determining whether or not the user of the terminal itself is a driver while taking the terminal itself and the detected mobile terminal apparatus of the other user as candidate user terminals, on the basis of the ranking information of the setting information referred to from the storage; and
if the user of the terminal itself is the driver, a step of transmitting the driver information to the in-vehicle apparatus, and causing the in-vehicle apparatus to set and control the vehicle to be fitted with the driver by using the driver information.
